(19) United States
(12) Patent Application Publication
(10) Pub. No.: US 2026/0316537 A1
(43) Pub. Date: Oct. 15, 2026

(54) TRANSFORMABLE ARTICLE CARRIER SYSTEM

(71) Applicant: Re:Car Inc., Troy, MI (US)

(72) Inventors: Jordan Nizza, Long Beach, CA (US); Ben Rowley, Oak Park, MI (US); Scott Anderson, Commerce Twp., MI (US); Kirill Ponomarenko, Huntington Woods, MI (US); Gustavo Bizyk, Los Angeles, CA (US); Henri Kavaja, Laguna Niguel, CA (US)

(21) Appl. No.: 19/644,595

(22) Filed: Apr. 10, 2026

Related U.S. Application Data
(60) Provisional application No. 63/786,778, filed on Apr. 10, 2025.

(51) Int. Cl. B60J 7/16; B60J 7/185; B62D 33/02

(52) U.S. Cl. CPC B60J 7/1607; B60J 7/1856; B62D 33/0207

(57) ABSTRACT

A transformable article carrier system (e.g., a roof rack system) for an automotive vehicle having a vehicle frame, the automotive vehicle being reversibly configurable between a pickup truck configuration and a sport utility vehicle configuration, the transformable article carrier system being capable of being reversibly modified among a first state for use on the vehicle is in its pickup truck configuration and a second state for use on the vehicle when it is in its sport utility vehicle configuration.

### CROSS-REFERENCE TO RELATED APPLICATIONS

The present application claims the benefit of the filing date of United States Application Serial No. 63/786,778, filed Apr. 10, 2025, the contents of which are incorporated by reference in its entirety.

### FIELD

The present teachings relate generally to article carriers, and more particularly an article carrier system that is reversibly transformable from one state to another for use on an automotive vehicle that is reversibly configurable between a pickup truck configuration and a sport utility vehicle configuration.

### BACKGROUND

Traditional article carriers for automotive vehicles, particularly original equipment manufactured vehicles, are commonly bespoke for the particular vehicle. As a result, there is often a need for particular hardware that is unique to the vehicle body exterior surfaces.

To date, efforts to make an automotive vehicle that is reversibly configurable between a pickup truck configuration and a sport utility vehicle configuration have been unsuccessful on a serial production scale.

There is thus a need for an article carrier system that is reversibly transformable from one state to another for use on an automotive vehicle that is reversibly configurable between a pickup truck configuration and a sport utility vehicle configuration.

### SUMMARY

These teachings provide a transformable article carrier system for an automotive vehicle having a vehicle frame. The automotive vehicle may be reversibly configurable between a pickup truck configuration and a sport utility vehicle configuration. The transformable article carrier system may be capable of being reversibly modified among a first state for use on the vehicle when it is in the pickup truck configuration and a second state for use on the vehicle when it is in the sport utility vehicle configuration. The transformable article carrier system may include a first pair of longitudinally aligned spaced apart rails being a first left rail and a first right rail, each having a first length and being configured for attachment to a roof of the vehicle on either side of a central longitudinal axis of the vehicle. Each rail may have a forward end and a rearward end.

The transformable article carrier system may also include a rear transverse end bar having a first end corner region being a left end region and a second end corner region being a right end region. The transformable article carrier system may be connected at the first end corner region to the first left rail and may be connected at the second end corner region to the first right rail. The connections of the first end corner region and the second end corner region may be located at the rearward end of each respective rail.

The transformable article carrier system may also include an adjustable cross bar located forward of the rear transverse end bar and being longitudinally adjustable between at least two positions. The rear transverse end bar may be mechanically securable via a friction fit, an interlock, a cam lock, a locking pin through an opposing aperture, or a clamp to the rails, between at least two positions. The transformable article carrier system may also include an end cap that covers the forward end of each of the rails.

The transformable article carrier system may be reversibly transformable from a first state in which the transformable article carrier is attached to the roof of a vehicle configured as a pickup truck having no rear seat and no cargo area enclosure to a second state when the transformable article carrier is attached to the roof of a vehicle configured as a sport utility vehicle having a rear seat and/or a cargo area enclosure.

The transformable article carrier system may include at least one second pair of longitudinally aligned spaced apart rails being a second left rail and a second right rail, each having a second length and being configured for attachment using original equipment hardware provided on the vehicle frame including frame fastening devices, accessory fastening devices, weld nuts, a threaded opening, and/or a threaded fastener that is exposed and visible to an observer located outside of the vehicle and within 3 meters of the hardware to the roof of a vehicle on a respective side of a central longitudinal axis of the vehicle. Each rail of the second pair of longitudinally aligned spaced apart rails may have a forward end and a rearward end. The second length may be longer than the first length by at least 120% and/or the second length may be longer than the first length by less than 400%.

Any or all of the rails of the first or second pairs of longitudinally aligned spaced apart rails may have a constant profile over at least 50% of its respective first or second length.

Each of the longitudinally aligned spaced apart rails may be an extrusion that defines a longitudinally extending slot. Each of the longitudinally aligned spaced apart rails may be configured to include a longitudinally extending slot that includes a slot opening along the longitudinal direction that faces toward the central longitudinal axis of the vehicle. Each of the longitudinally aligned spaced apart rails may be configured to be interchangeably used on either side of the vehicle. Also, any longitudinally extending slot may be configured for providing a T-profiled track along which an adjustable cross bar can slide.

The rear transverse end bar may have an arcuate corner geometry at each of the first end corner region and the second end corner region for defining a bow structure. The rear transverse end bar may be elevated and spaced apart from a roof surface of the vehicle.

The transformable article carrier system may include a stanchion for supporting either or both of the rear transverse end bar and one of the rails. The stanchion may be configured with a lower portion that secures to a roof of the vehicle using original equipment hardware provided on the vehicle frame and/or the roof of the vehicle, including frame fastening devices, accessory fastening devices, weld nuts, a threaded opening and/or a threaded fastener that may be exposed and visible to an observer located outside of the vehicle and within 3 meters of the hardware. An upper portion may wrap partially or entirely around an outer end bar and/or outer rail surface and exhibiting a c-shape.

The rear transverse end bar may abuttingly and/or matingly and/or removably engage with each of the longitudinally aligned spaced apart rails. The first end corner region of the rear transverse end bar may engage the rearward end of one of the rails. The second end corner region may engage the rearward end of the other rail.

The transformable article carrier system may also include a forward transverse end bar. The forward transverse end bar may have a first end corner region and a second end corner region, and may be connected at its first end corner region to one of the longitudinally aligned spaced apart rails of the second pair and may be connected at its second end corner region to the other one of the longitudinally aligned spaced apart rails of the second pair. The connections of the first end corner region and the second end corner region may be located at the forward end of each respective rail.

The forward transverse end bar may have an arcuate corner geometry at each of the first end corner region and the second end corner region for defining a bow structure. The forward transverse end bar may exhibit a mirror symmetry with the rear transverse end bar. The forward transverse end bar may be elevated and spaced apart from a roof surface of the vehicle. The forward transverse end bar may matingly and/or abuttingly and/or removably engage with each rail of the second pair of the longitudinally aligned spaced apart rails. The first end corner region of the forward transverse end bar may engage the forward end of one of the rails. The second end corner region of the forward transverse end bar may engage the forward end of the other rail.

The end cap that covers the forward end of each of the rails may fasten to the roof of the vehicle and/or the vehicle frame. The end cap that covers the forward end of each of the rails may include one or any combination of (i) a contoured forward portion that may have an outer surface that extends slopingly beyond and beneath a planar roof portion toward a windscreen of the vehicle; (ii) a rearward portion that may have an upper portion and a lower portion configured to matingly and/or abuttingly and/or removably engage with the forward end of each of the rails to maintain the rails elevated and spaced apart from a roof surface of the vehicle.

The rails and the rear transverse end bar and the adjustable cross bar may share a common plane over most of its overall length. The end caps may have a forward most end that is located below the common plane. The end caps may have a forward most end that is located below the bottom of any stanchion after vehicle installation. The end caps may have a forward most end that adjoins a top of the front wind screen within a distance of less than 5 cm.

The adjustable cross bar may be configured to slide fore and aft along the respective longitudinally aligned spaced apart rails. The adjustable cross bar may be configured to be secured in place upon reaching a desired position by a mechanical attachment which may include an interference fit which may include a friction fit, an interlock, a cam lock, a locking pin through an opposing aperture, or a clamp.

The adjustable cross bar may be configured at its ends to include a projection that is insertable to define an interference fit within a complementary opening in the longitudinally aligned spaced apart rails to resist removal in response to transverse forces.

The transformable article carrier system may also include a pair of longitudinally aligned slotted bed rails for attachment to an upper portion of a bed wall of a vehicle in the pickup truck configuration. At least one upright assembly may secure to the slotted bed rails and may include one first upright arm that may be attachable to a respective slotted bed rail, and another second upright arm that may be attachable to the other respective slotted bed rail. The first and the second upright arms may be joined together by an adjustable cross bar. The at least one upright assembly may be longitudinally adjustable and securable between different longitudinal positions.

Any adjustable cross bar, any end bar, and/or any rail may include a profile geometry that provides a track on at least two portions of the profile. The profile geometry may define a T-shaped slot profile along at least 50% of its length. The profile geometry may define at least two T-shaped slot profiles located at an angle relative to each other, vertically aligned with each other, or juxtaposed with each other.

The vehicle may include the transformable article carrier system, where the vehicle may have a vehicle frame that in its original equipment condition includes a roof panel support structure. The roof panel support structure may include four fastening sites defined therein in the form of frame fastening devices, accessory fastening devices, weld nuts, a threaded stud, or a threaded opening. The four fastening sites may be located respectively at corner regions of the roof of the vehicle, within 20 centimeters of an upper end of each of a left vehicle A-pillar, a right vehicle A-pillar, a left vehicle B-pillar and a right vehicle B-pillar of the vehicle.

The vehicle may be reversibly configurable between a pickup truck and a sport utility vehicle, without destruction of vehicle components. The vehicle may include a propulsion system that is electric and is free of an internal combustion engine.

These teachings may provide a method of using the transformable article carrier system. The method may include one or more steps. The one or more steps may include installing the transformable article carrier system on the reversibly configurable vehicle when the vehicle is in a pickup truck configuration using the first pair of longitudinally aligned spaced apart rails. The one or more steps may include replacing the first pair of longitudinally aligned spaced apart rails with the second pair of longitudinally aligned spaced apart rails that are longer than the first pair, when the vehicle is in the sport utility vehicle configuration. The one or more steps may include removing any end caps. The one or more steps may include attaching a forward transverse end bar.

### BRIEF DESCRIPTION OF THE DRAWINGS

FIG. 1A is a perspective view of an illustrative reconfigurable vehicle in a pickup truck configuration without an article carrier system;

FIG. 1B is a perspective view of the illustrative reconfigurable vehicle in a sport utility configuration without an article carrier system;

FIG. 2A is a perspective view of the illustrative reconfigurable vehicle in the pickup truck configuration with the article carrier system;

FIG. 2B is a perspective view of the illustrative reconfigurable vehicle in the sport utility configuration with the article carrier system;

FIG. 3A is a close-up perspective view of FIG. 2A;

FIG. 3B is an exploded perspective view of the article carrier system illustrated in FIG. 3A;

FIG. 4 is a close-up perspective view of the illustrative reconfigurable vehicle in the pickup truck configuration;

FIG. 5 is a perspective view of the illustrative reconfigurable vehicle in the pickup truck configuration showing an example overhead rack in accordance with the present description;

FIG. 6A is an illustrative profile geometry for a rail in accordance with the present description;

FIG. 6B is an illustrative profile geometry for an adjustable cross bar in accordance with the present description;

FIG. 7 is an illustrative profile geometry for an upright arm in accordance with the present description;

FIG. 8 is a perspective view of the illustrative reconfigurable vehicle in the pickup truck configuration with the article carrier system;

FIG. 9 is a perspective view of the illustrative reconfigurable vehicle in the pickup truck configuration with the article carrier system;

FIG. 10 a perspective view of the illustrative reconfigurable vehicle in the sport utility configuration with the article carrier system;

FIG. 11 is a perspective view of the illustrative reconfigurable vehicle in the sport utility configuration with the article carrier system;

FIG. 12 is a perspective view of the illustrative reconfigurable vehicle in the sport utility configuration with the article carrier system;

FIG. 13 is a close-up perspective view of the illustrative reconfigurable vehicle in the pickup truck configuration with the article carrier system;

FIG. 14 is a close-up perspective view of the illustrative reconfigurable vehicle in the pickup truck configuration;

FIG. 15 is a perspective view of the illustrative reconfigurable vehicle in the pickup truck configuration showing an example overhead rack in accordance with the present description;

FIG. 16 is a perspective view of the illustrative reconfigurable vehicle in the pickup truck configuration showing an example overhead rack in accordance with the present description;

FIG. 17 is a perspective view of the illustrative reconfigurable vehicle in the pickup truck configuration showing an example overhead rack in accordance with the present description.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present description pertains to a transformable article carrier system (e.g., a roof rack system) for an automotive vehicle having a vehicle frame. The automotive vehicle may be reversibly configurable between a pickup truck configuration and a sport utility vehicle configuration. The article carrier system thus may be capable of being reversibly modified and/or configurable among a plurality of different operational states (e.g., a first state for use on the vehicle is in its pickup truck configuration and a second state for use on the vehicle when it is in its sport utility vehicle configuration).

For example, the article carrier according to this description is suitable for use with and adapted for use with the reconfigurable vehicle in US 63/785,542 filed on April 08, 2025, US 63/788,545 filed on April 14, 2025, US 63/792,518 filed on April 22, 2025, and US 19/642,294 filed on April 08, 2026 the entirety of which are hereby incorporated by reference herein in their entirety for all purposes.

By way of summary, the vehicle for which this article carrier is adapted for can be reconfigured from a first vehicle configuration to a second vehicle configuration. The vehicle can be reconfigured back to the first vehicle configuration. In other words, the vehicle has a reversibly configurable structure. In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

One of the vehicle configurations (e.g., first vehicle configuration or second vehicle configuration) may be a pickup truck or pickup truck configuration. The other vehicle configuration (e.g., first vehicle configuration or second vehicle configuration) may be a sport utility vehicle (SUV) or SUV configuration.

A “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing, hauling, and/or transporting cargo. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulkhead panel and rear window or glass assembly that can be completely removed or separated from the vehicle.

A “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added. The SUV configuration may have a substantially horizontal roof with a substantially vertical rear hatch, or the SUV configuration may have a substantially horizontal roof with a sloped rear hatch (e.g., a “fastback” configuration).

In the context of the present description, “original equipment” includes automotive vehicles and their respective components in a state as assembled during the construction of the vehicles as new vehicles. In contrast, “aftermarket” equipment includes components made by companies other than the original equipment manufacturer, which might be installed as replacements or enhancements after the car comes out of the factory. Article carriers of the present description may be provided as components of original equipment vehicle, and/or provided as aftermarket equipment for installation on an original equipment vehicle (optionally using at least some of the hardware provided in the original equipment vehicle).

“Sport utility vehicle” is not intended to be limited to any particular chassis construction and may include a vehicle that has a unibody construction, a body-on-frame construction, or any other construction.

In the context of the present description, an automotive vehicle may be reversibly configurable between a pickup truck configuration and a sport utility vehicle configuration. In this regard, the reversible configuration may enable conversion from one configuration to the other with non-destructive techniques, e.g., with detachment, relocation, and re-attachment of some or all components by use, for instance, of mechanical disconnection and connection techniques (e.g., by use of reversible mechanical fastening such as unfastening original equipment vehicle hardware, optionally repositioning a component and/or installing an additional component, and re-fastening at least some of the original equipment vehicle hardware). The attachment locations at which reversible mechanical fasteners are employed may be at locations predetermined by the original equipment manufacturer, and/or using hardware provided by the original equipment manufacturer for the purpose of enabling reconfiguration of the vehicle.

Among the many features of the present teachings, is that the article carrier systems make use of a unique vehicle frame construction. In particular, a “frame” may refer to a vehicle portion, shell, or skeleton that imparts structural integrity to the vehicle, whether to the entire vehicle and/or a portion only of the vehicle. A frame typically is a part of the vehicle that provides support for one or more vehicle body panels, interior components, and/or a part of the vehicle to which other vehicular components can be attached. For example, one or more interior vehicle components (e.g., interior panels, vehicle seats, dashboard, etc.) of the vehicle may be attached or supported on the frame. For example, one or more exterior vehicle components (e.g., exterior panels, doors, lights, windows, etc.) of the vehicle may be attached or supported on the frame. A frame may include one or more (e.g., a pair of spaced apart longitudinally extending) frame rails that extend from a rear end portion of the vehicle at least partially along the length of the vehicle towards the front end of the vehicle. A frame may include one or a plurality of subframes. The subframes may be configured to absorb energy and have a controlled impact response in the event of a small overlap frontal impact and/or a direct frontal impact.

The frame may include structural components such as A-pillars, B-pillars, floor, and cargo area walls. In some configurations, one or more elements of the frame may be permanently connected together such as via welding, riveting, and/or adhesive bonding. The vehicle frame or structural components of the vehicle frame may be made of a high strength architecture made of metal, aluminum, and/or steel. The frame may include a plurality of fastener elements (e.g., weld nuts, self-clinching nuts, blind rivet nuts, rivets or other threaded inserts) located at predefined locations and configured to receive another fastener element for attaching vehicle components (e.g., body panels, article carriers, or the like) to the frame.

In general, the present teachings envision an article carrier system that may include a first pair of longitudinally aligned spaced apart rails (e.g., a first left rail and a first right rail) each having a first length and being configured for attachment to the vehicle (e.g., to a roof of the vehicle) on a side (e.g., on either side) of a central longitudinal axis of the vehicle. For example, the rails may be spaced apart from each other (e.g., by a distance of one to two meters) and be positioned adjacent a side of the vehicle. Each rail may have a forward end and a rearward end. The rails may be configured for reversible attachment to the vehicle, in that they may employ suitable hardware, at least some of which can be re-used after attaching the rail(s) to the vehicle or detaching the rail(s) from the vehicle. Attachment to the vehicle may involve using original equipment hardware provided on the vehicle frame, such as frame fastening devices, accessory fastening devices, weld nuts, a threaded opening, and/or a threaded fastener that is exposed and visible to an observer located outside of the vehicle and within 3 meters of the hardware. At a given fastener location, there may be one or more fasteners which may be longitudinally separated and spaced apart by less than 10 centimeters.

The article carrier system may include a rear transverse end bar. Such rear transverse end bar may have a first end corner region (e.g., a left corner region) and a second end corner region (e.g., a right corner region). Each corner region may have an arcuate geometry. For example, the rear transverse end bar may include an arcuate corner geometry at each of the first end corner region and the second end corner region for defining a bow structure. The rear transverse end bar may have a constant profile. The rear transverse end bar may include free ends that have a cross-sectional profile geometry that approximates the profile geometry of the rails at their location of connection. The rear transverse end bar may be connected at the first end corner region to one of the longitudinally aligned spaced apart rails (e.g., the left corner region connected with the left rail). The rear transverse end bar may be connected at the second end corner region to the other one of the longitudinally aligned spaced apart rails (e.g., the right corner region connected with the right rail). The connections of the left corner region and the right corner region with each respective rail may be at the rearward ends of each respective rail. The left corner region may be interchangeable with the right corner region.

The rear transverse end bar may be elevated and spaced apart from a roof surface of the vehicle. A suitable support may provide such elevation and spacing. For example, there may be employed a stanchion, preferably a plurality of stanchions, that connects directly or indirectly with the rear transverse end bar (e.g., the left corner region and the right corner region, respectively) in order to maintain the elevation and spacing. Such a stanchion may be configured with a lower portion that secures to a vehicle (e.g., to a roof) using original equipment hardware provided on the vehicle frame. For example, the original equipment hardware may include frame fastening devices, accessory fastening devices, weld nuts, a threaded opening, and/or a threaded fastener that is exposed and visible to an observer located outside of the vehicle and within 3 meters of the hardware. At a given fastener location, there may be one or more fasteners which may be longitudinally separated and spaced apart by less than 10 centimeters. The stanchion may also include an upper portion that receives the rear transverse end bar (and/or a rail). The upper portion may wrap partially or entirely around an outer portion of the rear transverse end bar and/or rail surface. For example, the stanchion may include an upper portion that exhibits a c-shape. The extensions of the stanchion forming the c-shape may receive the outer rear transverse end bar and/or rail surface. The stanchions may be configured to be interchangeably used on either side of the vehicle.

The stanchion may include or provide a coupling for connecting two adjoining components (e.g., a rail connected with a rear transverse end bar). The upper portion and the lower portion may clamp together with the rail and/or the rear transverse end bar therebetween. The stanchion upper portion may may have a clamshell arrangement or may include two or more separable components that can join (e.g., clamp) together with the rail and/or rear transverse end bar therebetween. Between the separable components (e.g., upper portion and lower portion) of the stanchion there may be a male portion formed therein or a tongue that can matingly engage with the slot of the rail and/or rear transverse end bar. In this way, the left corner region engages the left rail, and the right corner region engages the right rail.

The longitudinally aligned spaced apart rails may be an extrusion or pultrusion that defines a longitudinally extending slot. Each of the rails may be configured to include a longitudinally extending slot that includes a slot opening along the longitudinal direction that faces toward the central longitudinal axis of the vehicle. Each of the longitudinally aligned spaced apart rails may be configured to be interchangeably used on either side of the vehicle. Any longitudinally extending slot may be configured for providing a track (e.g., a T-profiled track) along which an adjustable cross bar, or a plurality of adjustable cross bars, can slide (e.g., via a bracket on the adjustable cross bar or other suitable structure). For example, the adjustable cross bar may include a T-shaped profile that fits complementarily within a T-profiled track profile of a rail to allow movement along the track.

Thus, the article carrier system may include an adjustable cross bar, or a plurality of adjustable cross bars, located forward of the rear transverse end bar and being longitudinally adjustable between at least two positions. The adjustable cross bar may be securable to the rails, and configured for longitudinal adjustment between at least two positions via each slot on the longitudinally aligned spaced apart rails. By way of example, the adjustable cross bar may have an associated structure, such as an end bracket, that provides a mechanism to permit a mechanical locking attachment to the rails. The mechanical locking attachment may provide a friction fit, an interlock, a cam lock, a locking pin through an opposing aperture, a clamp, or other like structure that allows for unlocking the adjustable cross bar, translating it fore or aft, and locking it in place at the desired location along to the rails. For example, the mechanical locking attachment may be a bracket that may include a clamp that can be tightened to bear against the inner wall defining the slot in the rail, and can be loosened to allow fore and aft adjustment. The bracket may enable the adjustable cross bar to resist removal from the slot in response to transverse forces. The adjustable cross bar may be configured at its ends to include a projection that is insertable to define an interference fit within a complementary opening in the longitudinally aligned spaced apart rails and/or stanchions. The projection may be a part of the bracket attached to an end of the adjustable cross bar. The rails, the rear transverse end bar, and the adjustable cross bar may share a common plane.

Optionally, an end cap may be employed to cover at least the forward end of each of the rails. The end cap may be ornamental in nature. It may fasten to a vehicle roof, e.g., to a vehicle frame and/or using original equipment hardware. It may include a forward portion that slopes downward. The forward portion may have an outer surface that may be below the roof of the vehicle toward the wind screen of the vehicle. It may include a portion (e.g., rearward portion) that enables its associated rail to be elevated and spaced apart from an exterior surface of the vehicle. The rearward portion may have an upper portion and a lower portion that engage with the rails to maintain the rails elevated and spaced apart from the roof of the vehicle. The forward portion may have a forward contoured edge region and the rearward portion may have a rearward contoured edge region. The radius of curvature of edge regions may differ in a manner to enable the elevation and spacing from the roof. The end cap may be fastened to the vehicle roof and/or vehicle frame via a fastener (e.g., screw, bolt, or the like). The end cap may have a cover that is configured to cover the fastener when viewed from above. An end cap may be connected to a front spoiler or wing. The end cap may have at least one through hole which may permit access to attachment hardware and/or to a front spoiler or wing. There may be a gap between the front spoiler or wing and the forward end of the roof. Additionally or alternatively, there may not be a gap, or a very little gap, between the front spoiler or wing and the forward end of the roof. Thus, the end cap may adjoin a top of the front wind screen within a distance of less than 1 centimeter.

In another example, each end cap may have a forward portion that slopes downward having an outer surface that is below the planar roof toward the wind screen of the vehicle and a rearward portion that may have one or more end cap slots to receive one or more adjustable cross bars and/or brackets. The bracket may provide a mechanism to permit a mechanical locking attachment to the end cap slot. As possible with other mechanical locking attachments herein, the bracket may include a clamp that can be tightened to bear against the inner wall defining the end cap slot, and can be loosened to allow fore and aft adjustment. The bracket may enable the adjustable cross bar to resist removal from the end cap slot in response to transverse forces. The adjustable cross bar may be configured at its ends to include a projection that is insertable to define an interference fit within a complementary opening in the end cap slot. The projection may be a part of the bracket attached to an end of the adjustable cross bar. The end cap may be fastened to the vehicle roof and/or vehicle frame via at least one fastener (e.g., screw, bolt, or the like). The end cap may adjoin a top of the front wind screen within a distance of less than 1 centimeter. The adjustable cross bar may be configured to support one or more lights.

For various purposes, including stability and promoting a unique and aesthetically pleasing appearance, the rails and rear transverse end bar and optionally the adjustable cross bar share a common plane over most of its overall length (e.g., at least 50%, preferably 65%, and more preferably 80% or more), and optionally the end caps have a forward-most end that is located below the common plane, and/or located below the bottom of any stanchion after vehicle installation. The end caps may adjoin a top of the front wind screen within a distance of less than 5 cm, more preferably less than 3 cm, and still more preferably less than 1 cm.

One unique aspect of the present teachings is that a transformable article carrier system is realized by which the article carrier can be reversibly transformable from a first state in which the article carrier is attached to a roof of a vehicle configured as a pickup truck (e.g., having no rear seat and no cargo area enclosure) to a second state when the vehicle is configured as a sport utility vehicle (e.g., having a rear seat and/or a cargo area enclosure).

The transformable article carrier system herein may include at least one second pair of longitudinally aligned spaced apart rails (e.g., a second left rail and a second right rail) each having a second length and being configured for attachment to a roof of a vehicle on a respective side of a central longitudinal axis of the vehicle. For example, the rails may be spaced apart from each other (e.g., by a distance of one to two meters) and be positioned adjacent a side of the vehicle. The rails may be configured for reversible attachment to the vehicle, in that they may employ suitable hardware, at least some of which can be re-used after attaching the rail(s) to the vehicle or detaching the rail(s) from the vehicle. Attachment to the vehicle may involve using original equipment hardware provided on the vehicle frame, such as frame fastening devices, accessory fastening devices, weld nuts, a threaded opening, and/or a threaded fastener that is exposed and visible to an observer located outside of the vehicle and within 3 meters of the hardware. At a given fastener location, there may be one or more fasteners which may be longitudinally separated and spaced apart by less than 10 centimeters. The transformable article carrier system herein may include at least one pair of roof slots (e.g., a left roof slot and a right roof slot).

Each rail of the second pair of longitudinally aligned spaced apart rails may have a forward end and a rearward end. The second length may be longer than the first length by at least 120%, preferably at least 150% and more preferably at least 200% and/or the second length is longer than the first length by less than 400%, preferably less than 350% and more preferably less than 300%. For example, for purposes of illustration, a first rail may have a first length of 100 centimeters, and a second rail may have a second length of 150% the first length, 150 centimeters.

Any or all of the rails of the first or second pairs of longitudinally aligned spaced apart rails may have a constant profile over at least 50%, preferably at least 65%, more preferably at least 80%, and still more preferably at least 95% of its respective first length or second length.

Each rail of the second pair of longitudinally aligned spaced apart rails may be an extrusion or pultrusion that defines a longitudinally extending slot. Each of the rails may be configured to include a longitudinally extending slot that includes a slot opening along the longitudinal direction that faces toward the central longitudinal axis of the vehicle. Each of the longitudinally aligned spaced apart rails may be configured to be interchangeably used on either side of the vehicle. Any longitudinally extending slot may be configured for providing a track (e.g., a T-profiled track) along which an adjustable cross bar, or a plurality of adjustable cross bars, can slide (e.g., via a bracket on the adjustable cross bar or other suitable structure). For example, the adjustable cross bar may include a T-shaped profile that fits complementarily within a T-profiled track profile of a rail to allow movement along the track.

In regard to the rear transverse end bar, it may include a first end corner region (e.g., a left corner region) and a second end corner region (e.g., a right corner region). Each corner region may have an arcuate geometry. For example, the rear transverse end bar may include an arcuate corner geometry at each of the first end corner region and the second end corner region for defining a bow structure. The rear transverse end bar may have a constant profile. The rear transverse end bar may include free ends that have a cross-sectional profile geometry that approximates the profile geometry of the rails at their location of connection.

The rear transverse end bar may be elevated and spaced apart from a roof surface of the vehicle. A suitable support may provide such elevation and spacing. For example, there may be employed a stanchion, preferably a plurality of stanchions, that connects directly or indirectly with the rear transverse end bar (e.g., the left corner region and the right corner region, respectively) in order to maintain the elevation and spacing. Such a stanchion may be configured with a lower portion that secures to a vehicle (e.g., to a roof) using original equipment hardware provided on the vehicle frame and/or the vehicle roof. For example, the original equipment hardware may include frame fastening devices, accessory fastening devices, weld nuts, a threaded opening, and/or a threaded fastener that is exposed and visible to an observer located outside of the vehicle and within 3 meters of the hardware. At a given fastener location, there may be one or more fasteners which may be longitudinally separated and spaced apart by less than 10 centimeters. The stanchion may also include an upper portion that receives the rear transverse end bar (and/or a rail). The upper portion may wrap partially or entirely around an outer portion of the rear transverse end bar and/or rail surface. For example, the stanchion may include an upper portion that exhibits a c-shape. The extensions of the stanchion forming the c-shape may receive the outer rear transverse end bar and/or rail surface. The stanchions may be configured to be interchangeably used on either side of the vehicle.

The stanchion may include or provide a coupling for connecting two adjoining components (e.g., a rail of the second pair of the longitudinally aligned spaced apart rails connected with a rear transverse end bar). The upper portion and the lower portion may clamp together with the rail and/or the rear transverse end bar therebetween. The stanchion upper portion may may have a clamshell arrangement or may include two or more separable components that can join (e.g., clamp) together with the rail and/or rear transverse end bar therebetween. Between the separable components (e.g., upper portion and lower portion) of the stanchion there may be a male portion formed therein or a tongue that can matingly engage with the slot of the rail and/or rear transverse end bar. In this way, the left corner region engages the left rail, and the right corner region engages the right rail.

The rear transverse end bar may matingly, abuttingly, and/or removably engage with each rail of the second pair of the longitudinally aligned spaced apart rails. For example, the first end corner region (e.g., the left corner region) of the rear transverse end bar may engage the rearward end of the left rail. The second end corner region (e.g., the left corner region) of the rear transverse end bar may engage the rearward end of the right rail. The left corner region may be interchangeable with the right corner region.

In one state, the article carrier of the system described herein may include a forward transverse end bar. Such forward transverse end bar may resemble and employ geometry like that of the rear transverse end bar (e.g., it optionally may exhibit mirror symmetry after installation). Thus, the forward transverse end bar may have an arcuate corner geometry at each of the first end corner region (e.g., a left corner region) and a second end corner region (e.g., a right corner region) for defining a bow structure. The forward transverse end bar may have a first end corner region and a second end corner region. The forward transverse end bar may be connected at its first end corner region to one of the longitudinally aligned spaced apart rails of the second pair and may be connected at its second end corner region to the other one of the longitudinally aligned spaced apart rails of the second pair. The connections of the first end corner region and a second end corner region may be located at the forward end of each respective rail. In this arrangement, the use of end caps may be omitted. As with the rear transverse end bar, the forward transverse end bar may be elevated and spaced apart from a roof surface of the vehicle (e.g., by use of a support such as a stanchion like that described previously). Additionally, the forward transverse end bar may matingly and/or abuttingly and/or removably engage with each rail of the second pair of the longitudinally aligned spaced apart rails. Thus, the first end corner region of the forward transverse end bar may engage the forward end of one of the rails (e.g., the left rail), and the second end corner region may engage the forward end of the other rail (e.g., the right rail). The rails, the rear transverse end bar, the adjustable cross bar(s), and the forward transverse end bar may share a common plane.

An end cap, when employed may cover the forward end of each rail of the second pair of the longitudinally aligned spaced apart rails. The end cap may be ornamental in nature. It may fasten to a vehicle roof, e.g., to a vehicle frame and/or using original equipment hardware. The end cap may include one or any combination of (i) a contoured forward portion that has an outer surface that extends slopingly beyond and beneath a planar roof portion toward a windscreen of the vehicle; (ii) a rearward portion that enables its associated rail to be elevated and spaced apart from an exterior surface of the vehicle and that has an upper portion and a lower portion configured to engage (e.g., matingly engage, abuttingly engage, removably engage) with the forward end of each of the rails to maintain the rails elevated and spaced apart from a roof surface of the vehicle. The forward portion may have a forward contoured edge region and the rearward portion may have a rearward contoured edge region. The radius of curvature of edge regions may differ in a manner to enable the elevation and spacing from the roof. The end cap may be fastened to the vehicle roof and/or vehicle frame via a fastener (e.g., screw, bolt, or the like). The end cap may have a cover that is configured to cover the fastener when viewed from above. An end cap may be connected to a front spoiler or wing. The end cap may have at least one through hole which may permit access to attachment hardware and/or to a front spoiler or wing. There may be a gap between the front spoiler or wing and the forward end of the roof. Additionally or alternatively, there may not be a gap, or a very little gap, between the front spoiler or wing and the forward end of the roof. Thus, the end cap may adjoin a top of the front wind screen within a distance of less than 1 centimeter.

For various purposes, including stability and promoting a unique and aesthetically pleasing appearance, each rail of the second pair of the longitudinally aligned spaced apart rails and rear transverse end bar and optionally the adjustable cross bar share a common plane over most of its overall length (e.g., at least 50%, preferably 65%, and more preferably 80% or more), and optionally the end caps have a forward-most end that is located below the common plane, and/or located below the bottom of any stanchion after vehicle installation. The end caps may adjoin a top of the front wind screen within a distance of less than 5 cm, more preferably less than 3 cm, and still more preferably less than 1 cm.

The article carrier system may include an adjustable cross bar, or a plurality of adjustable cross bars, located forward of the rear transverse end bar and being longitudinally adjustable between at least two positions. The adjustable cross bar may be configured to slide fore and aft along the respective longitudinally aligned spaced apart rails of the second pair. The adjustable cross bar may also be configured to be secured in place upon reaching a desired position. The securing in place may be by way of a suitable mechanical attachment. For example, there may be a structure, such as an end bracket, employed for defining an interference fit or some other interlock (e.g., a friction fit, an interlock, a cam lock, a locking pin through an opposing aperture, a clamp, or the like).

The adjustable cross bar may be configured at its ends to include a projection that is insertable to define an interference fit within a complementary opening in the longitudinally aligned spaced apart rails of the second pair and/or stanchions. The projection may be a part of a bracket attached to an end of the adjustable cross bar. The bracket that may include a clamp that can be tightened to bear against the inner wall defining the slot in the rail, and can be loosened to allow fore and aft adjustment. In this manner, the adjustable cross bar may be able to resist removal from the slot in response to transverse forces. Each rail of the second pair of the longitudinally aligned spaced apart rails, the rear transverse end bar, and the adjustable cross bar may share a common plane.

When the vehicle is configured as a sport utility vehicle (e.g., having a rear seat and/or a cargo area enclosure), the transformable article carrier system herein may not include a first or second pair of longitudinally aligned spaced apart rails for attachment to a roof of a vehicle on a respective side of a central longitudinal axis of the vehicle. The article carrier system may include a pair of roof slots (e.g., a left roof slot and a right roof slot). A plurality of stanchions may be located on the roof of the vehicle connected to the pair of roof slots. For example, a plurality of stanchions may connect to the left roof slot where at least one is located on a more forward portion of the vehicle roof, and a plurality of stanchions may connect to the right roof slot where at least one is located on a more forward portion of the vehicle roof. The stanchions may be interchangeable between the left roof slot and right roof slot. The stanchions may each have a lower portion that secures to the vehicle roof via the roof slots. The stanchions may each be longitudinally adjustable between at least two positions via the roof slots. The stanchions may each have an associated structure, such as an end bracket, that may provide a mechanism to permit a mechanical locking attachment to the roof slots. As possible with other mechanical locking attachments herein, the bracket may include a clamp that can be tightened to bear against the inner wall defining the roof slot, and can be loosened to allow fore and aft adjustment. The bracket may enable each of the stanchions to resist removal from the roof slots in response to transverse forces. The lower portion of the stanchion may be configured at its end to include a projection that is insertable to define an interference fit within a complementary opening in the roof slot. The projection may be a part of a bracket attached to an end of the lower portion of the stanchion. The stanchions may each have an upper portion positioned at an angle of substantially 90 degrees relative to the lower portion, where the upper portion may receive an adjustable cross bar and optionally a mechanical attachment (e.g., bracket) as described herein.

Another aspect of the article carrier system as described herein envisions a rack assembly and/or rack assembly system that supports articles overhead of a bed when the vehicle is in a pickup truck configuration. The rack assembly system may thus also include a pair of longitudinally aligned slotted bed rails (e.g., a left bed rail and a right bed rail) for attachment to an upper portion of a bed wall (e.g., an upper portion of the left bed wall and an upper portion of the right bed wall) of a vehicle when in a pickup truck configuration. The rack assembly optionally may include a slotted bed rail (e.g., a center bed rail) for attachment to an upper portion of a bed wall (e.g., an upper portion of the center bed wall (e.g., a bulkhead panel)). Any or all of the slotted bed rails be define a T-shaped slot.

Such rack assembly system may employ at least one upright assembly that secures to the slotted bed rails. The upright assembly may include a first upright arm (e.g., left upright arm) being attachable to a respective slotted bed rail (e.g., the left bed rail). A second upright arm (e.g., right upright arm) may be attachable to the other respective slotted bed rail (e.g., the right bed rail). The first upright arm and the second upright arm may be attachable to the slotted bed rails via a bracket and optionally a connection piece which may be connected by one or more fasteners (e.g., bolts, screws, etc.). The first upright arm and/or the second upright arm may have a profile geometry defining one or more T-shaped slots. The T-shaped slots may be defined on different sides of the first upright arm and/or the second upright arm. Additionally or alternatively, the T-shaped slots may be defined on the same side of the first upright arm and/or the second upright arm. Preferably, the profile geometry of the first upright arm and/or the second upright arm may resemble a rectangular shape where each side defines a T-shaped slot. The T-shaped slot may be configured to receive a component and/or a rubber seal. The first and the second upright arms may be joined together, preferably by an adjustable cross bar and/or one or more corner brackets which may be connected by one or more fasteners (e.g., bolts, screws, etc.). The at least one upright assembly may be longitudinally adjustable and securable between different longitudinal positions. This can be achieved using a suitable device, such as a device for use to securingly adjust the adjustable cross bar, as discussed above (e.g., a bracket and/or a connection piece and/or projection). The left upright arm and the right upright arm, and optionally the bracket and/or the connection piece and/or the corner brackets, may be interchangeable between the left side and the right side of the vehicle.

The rack assembly system may include two or more upright assemblies that secure to the slotted bed rails in which a pair of longitudinally extending adjustable cross bars join together the two or more upright assemblies. The longitudinally extending adjustable cross bar may be connected to the left upright arms and the right upright arms via an upright arm slot (e.g., T-shaped slot on each of the left upright arms and the right upright arms) and/or mechanical attachment (e.g., a bracket) and/or projection. The mechanical attachment (e.g., bracket) may provide a mechanism to permit a mechanical locking attachment to the upright arm slot. As possible with other mechanical locking attachments herein, the bracket may include a clamp that can be tightened to bear against an inner wall defining the upper arm slot, and can be loosened to allow vertical adjustment of the longitudinally extending adjustable cross bar. The bracket may enable each of the longitudinally extending adjustable cross bars to resist removal from the upper arm slot in response to transverse forces. The left upright arm and the right upright arm, and optionally the bracket and/or the connection piece and/or the corner brackets and/or the longitudinally extending adjustable cross bars, may be interchangeable between the left side and the right side of the vehicle.

In another example, the rack assembly system may include one or more upright assemblies secured to the slotted bed rails. The upright assembly may include two stanchions each having a lower portion that may be connected to the slotted bed rails (e.g., the left bed rail and the right bed rail). The stanchions may each be longitudinally adjustable between at least two positions via the slotted bed rails. The stanchions may each have an associated structure, such as an end bracket that may provide a mechanism to permit a mechanical locking attachment to the slotted bed rails. As possible with other mechanical locking attachments herein, the bracket may include a clamp that can be tightened to bear against the inner wall defining the slotted bed rails, and can be loosened to allow fore and aft adjustment. The bracket may enable each of the stanchions to resist removal from the slotted bed rails in response to transverse forces. The lower portion of the stanchion may be configured at its end to include a projection that is insertable to define an interference fit within a complementary opening in the slotted bed rails. The projection may be a part of a bracket attached to an end of the lower portion of the stanchion. The stanchions may each have an upper portion positioned at an angle of substantially 90 degrees relative to the lower portion, where the upper portion may receive an adjustable cross bar and optionally a mechanical attachment (e.g., bracket) as described herein. The two stanchions may be joined together by the adjustable cross bar. The stanchions may be interchangeable between the left bed rail and the right bed rail.

Any adjustable cross bar, any end bar (e.g., rear transverse end bar, forward transverse end bar), and/or any rail may include a profile geometry that provides a track on at least two portions of the profile, preferably at least three portions. The profile geometry may define a T-shaped slot profile along a major portion (e.g., at least 50%, preferably at least 65%, more preferably at least 80%, and still more preferably at least 95% or the entirety of its length). The profile geometry may define at least two or three T-shaped slot profiles located at an angle relative to each other, vertically aligned with each other, juxtaposed with each other or any combination.

The system may include three pairs of the longitudinally extending rails. In this scenario, two of the pairs may have the same length. In this scenario, one of the pairs (e.g., the third pair) may be configured to attach respectively to a left side wall and a right side wall of a pickup truck bed of the vehicle when it is in a pickup truck configuration. In such an instance, it is possible for the latter pair (e.g., the third pair) to receive within a slot of its profile a bracket or other suitable structure (e.g., as with other structure for sliding adjustment along a rail, having a T-shaped profile that fits complementarily within the profile of a rail). In this manner there may be provided a bar, a plate, a bracket or other structure that may be adjustably secured along the length of the third pair of rails for management of cargo carried in the bed.

A vehicle including the transformable article carrier system may have a vehicle frame that, in its original equipment condition includes a roof panel support structure, the roof panel support structure including a plurality of fastening sites (e.g., four) defined therein (e.g., in the form of frame fastening devices, accessory fastening devices, weld nuts, a threaded stud or a threaded opening) and located respectively at corner regions of the roof, preferably proximate (e.g., within 20 centimeters, or even 10 centimeters) of an upper end of each of a left vehicle A-pillar, a right vehicle A-pillar, a left vehicle B-pillar and a right vehicle B-pillar of the vehicle. At a given fastener location, there may be one or more fasteners which may be longitudinally separated and spaced apart by less than 10 centimeters.

As can be appreciated from the above description, the vehicle is reversibly configurable between a pickup truck and a sport utility vehicle, without destruction of vehicle components. It is desirable that the vehicle of the present teachings may include a propulsion system that is electric and is free of an internal combustion engine.

In order to transform the article carrier system of the teachings herein it is possible that a method is employed including installing the system on the vehicle as described. When the vehicle is in a pickup truck configuration the method may include unfastening the first pair of longitudinally aligned spaced apart rails; and replacing the first pair of longitudinally aligned spaced apart rails with a different pair, preferably the second pair, of longitudinally aligned spaced apart rails that are longer than the first pair to make the article carrier system suitable for use when the vehicle is in the sport utility vehicle configuration. In this manner, the method may include removing any end caps and/or attaching a forward transverse end bar, preferably a forward transverse end bar as described.

When the vehicle is in a pickup truck configuration the method may include unfastening the first pair of longitudinally aligned spaced apart rails; and replacing the first pair of longitudinally aligned spaced apart rails with one or more end caps and one or more adjustable cross bars to make the article carrier system suitable for use when the vehicle is in the pickup truck configuration.

When the vehicle is in a sport utility vehicle configuration the method may include unfastening the second pair of longitudinally aligned spaced apart rails; and replacing the second pair of longitudinally aligned spaced apart rails with a different pair, preferably the first pair, of longitudinally aligned spaced apart rails that are shorter than the second pair to make the article carrier system suitable for use when the vehicle is in the pickup truck configuration. In this manner, the method may include attaching the end caps and/or removing a forward transverse end bar.

When the vehicle is in a sport utility vehicle configuration the method may include unfastening the second pair of longitudinally aligned spaced apart rails; and replacing the second pair of longitudinally aligned spaced apart rails with one or more stanchions and one or more adjustable cross bars to make the article carrier system suitable for use when the vehicle is in the sport utility vehicle configuration. In this manner, the method may include removing a forward transverse end bar.

One benefit of the present teachings is that the use of original equipment hardware and/or attachment to a vehicle frame may enable assembly to be free of any tolerance compensation device. Another benefit is that use of original equipment hardware and frame structures for mounting makes for easy conversion by users, and reliable connections with attractive structural integrity.

### Illustrative Examples

The following descriptions of the Figures are provided to illustrate the teachings herein but are not intended to limit the scope thereof.

Turning now to the drawings to more particularly illustrate examples of the present description.

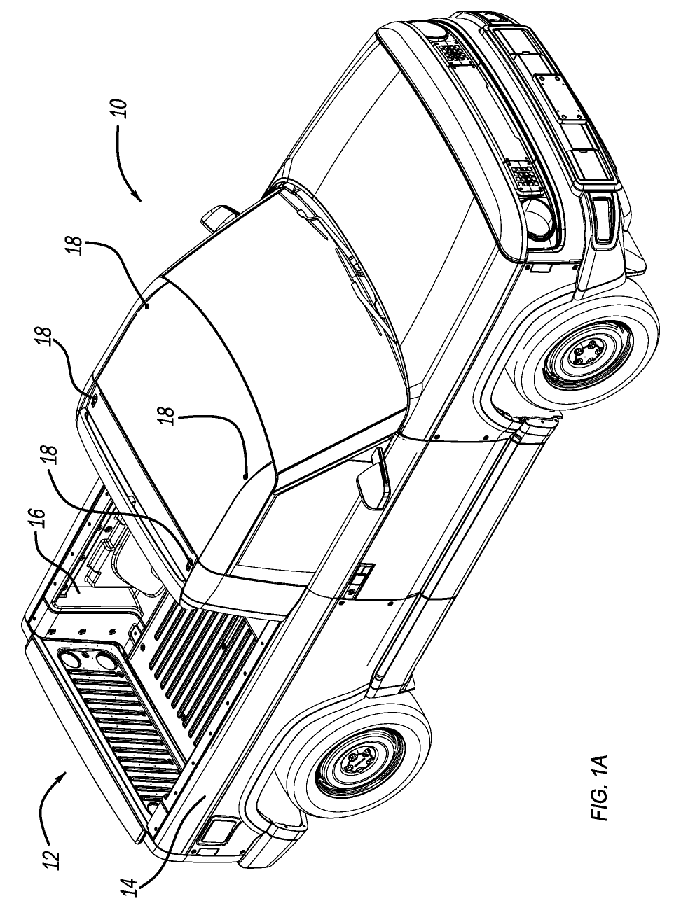

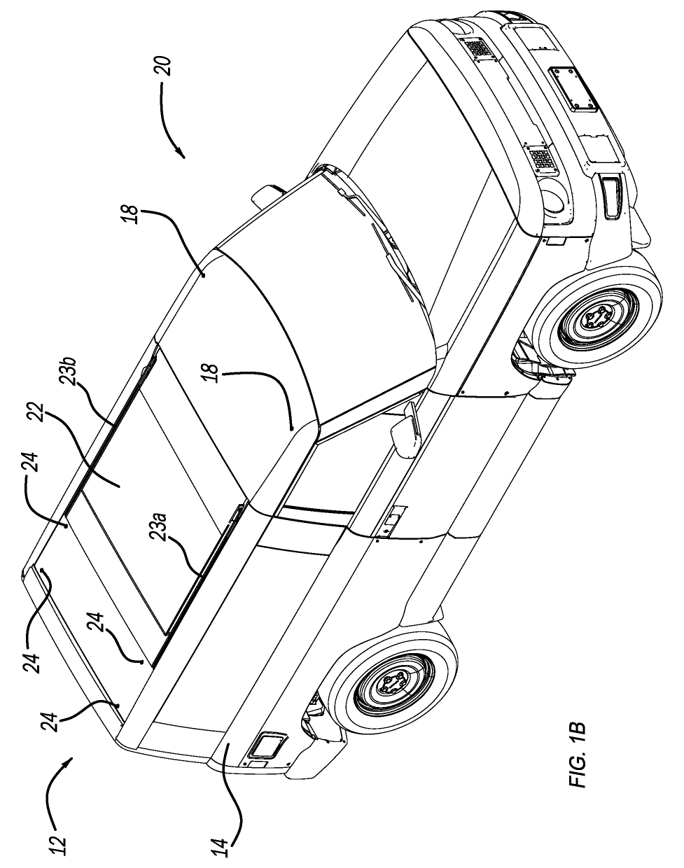

With reference to FIGS. 1A and 1B, there is depicted an example of a vehicle that is reversibly reconfigurable. A pickup truck configuration 10 is shown in FIG. 1A. It has a truck bed 12, having a first side wall 14 on the left and a second side wall 16 on the right. It also has a roof overlying a vehicle frame (not seen) at which there are four fasteners 18 depicted.

A sport utility vehicle (SUV) configuration 20 of the vehicle is seen in FIG. 1B. As seen in FIG. 1B, the SUV configuration 20 includes an enclosure 22 over the truck bed 12, two fasteners 18 on the roof, four fasteners 24 on the enclosure 22 (although the enclosure 22 may not have fasteners 24), and a pair of roof slots (e.g., a left roof slot 23a and a right roof slot 23b) on the enclosure 22.

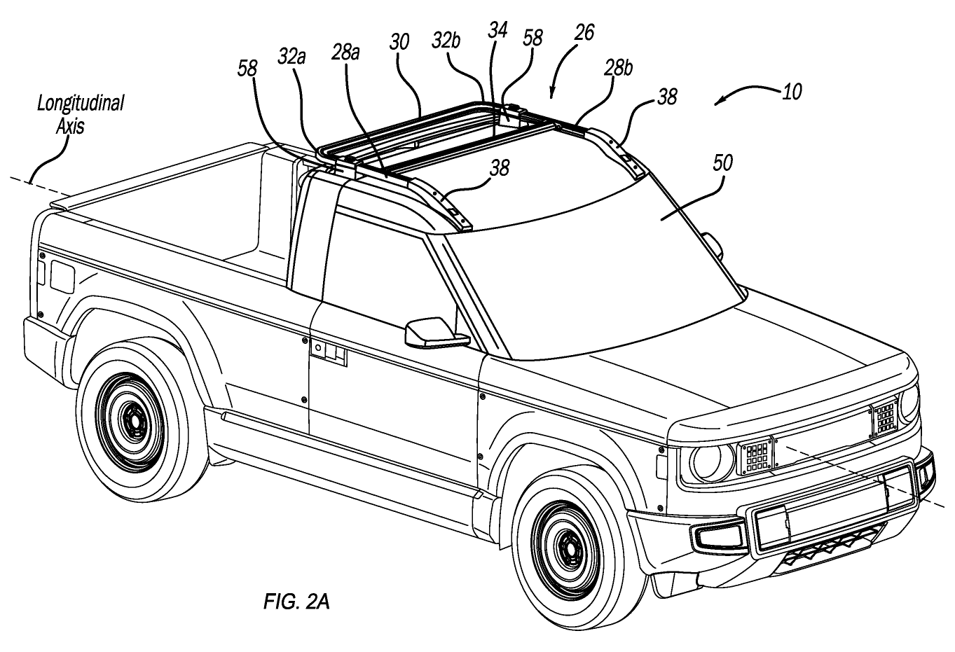

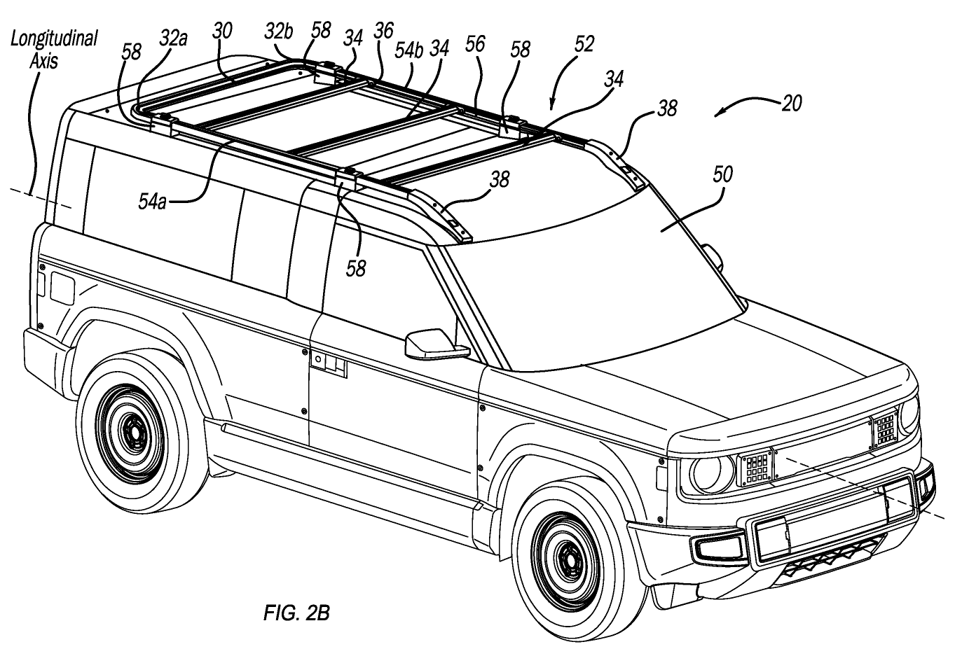

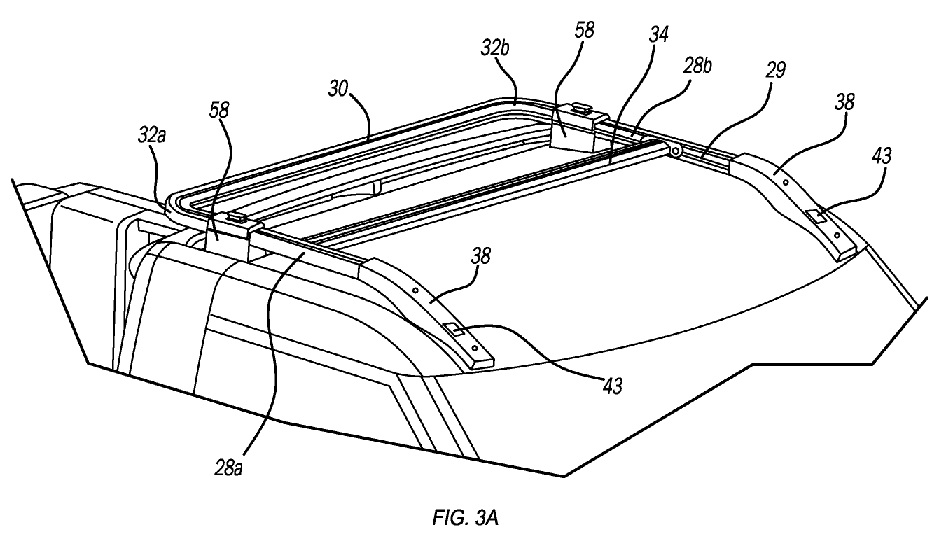

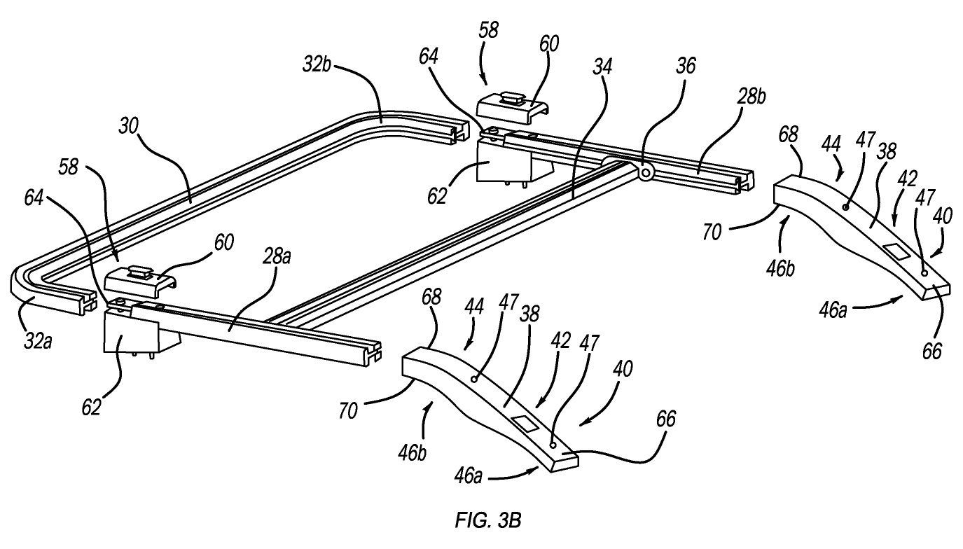

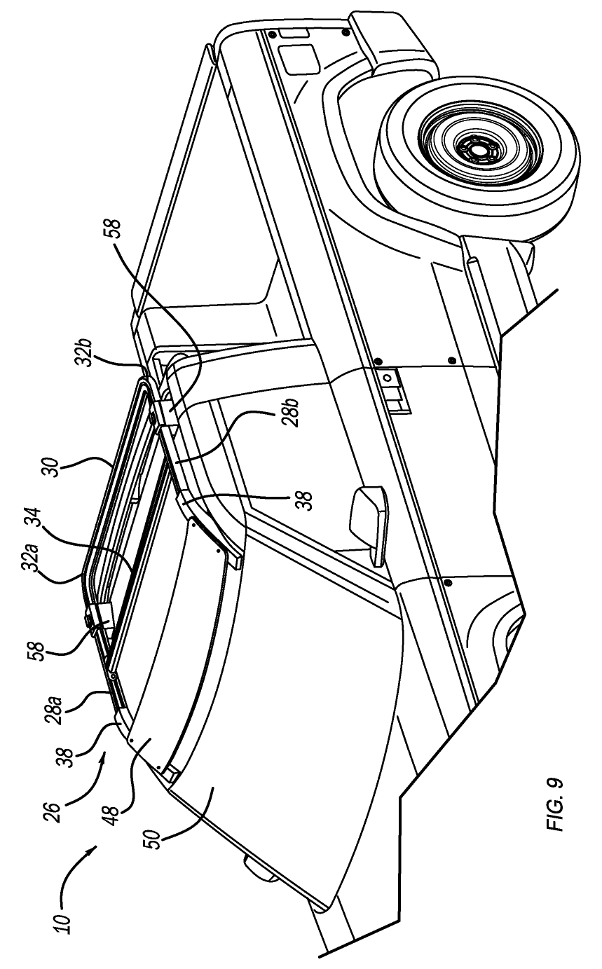

Turning to FIGS. 2A and 9, there is depicted the pickup truck configuration 10 having an article carrier system 26. The article carrier system 26 includes a first pair of longitudinally aligned spaced apart rails (e.g., a first left rail 28a and a first right rail 28b) each having a first length, each having a longitudinally extending slot 29 (FIG. 3A) that includes a slot opening along the longitudinal direction that faces toward the longitudinal axis (e.g., central longitudinal axis) of the vehicle, and being mounted on the vehicle roof.

The article carrier system 26 includes a rear transverse end bar 30. Such end bar 30 may have a first end corner region 32a on its left side (e.g., left corner region 32a) and a second end corner region 32b on its right side (e.g., right corner region 32b). The end bar 30 is connected at the left corner region 32a to the left rail 28a. The end bar 30 is connected at the right corner region 32b to the right rail 28b.

The rear transverse end bar 30 is elevated and spaced apart from a roof surface of the vehicle. Two stanchions 58 are located on the roof of the vehicle and connect to the left corner region 32a and the right corner region 32b, respectively, of the rear transverse end bar 30 to maintain the elevation and spacing. Each stanchion 58 has a lower portion that is secured to the vehicle roof and/or vehicle frame (not shown) and an upper portion that receives the rear transverse end bar 30. The upper portions of the stanchions 58 also receive rails 28a and 28b respectively.

As shown in FIG. 3B, the stanchion 58 has an upper portion 60 and a lower portion 62. The upper portion 60 and the lower portion 62 clamp together with the rail 28a, 28b and/or the rear transverse end bar 30 therebetween. Between the upper portion 60 and the lower portion 62 there may be a male portion 64 formed therein that can matingly engage with a slot of the rail 28a, 28b and/or a slot of the rear transverse end bar 30. In this way, the left corner region 32a engages the left rail 28a, and the right corner region 32b engages the right rail 28b.

Turning back to FIGS. 2A and 9, the article carrier system 26 includes an adjustable cross bar 34 located forward of the rear transverse end bar 30 and being longitudinally adjustable between at least two positions. The adjustable cross bar 34 may be securable to the rails 28a, 28b and configured for longitudinal adjustment between at least two positions via the slot 29. By way of example, the adjustable cross bar 34 may have an associated structure, such as an end bracket 36 (FIGS. 3B,6B, ) that provides a mechanism to permit a mechanical locking attachment to the rails 28a, 28b. As possible with other mechanical locking attachments herein, the bracket 36 illustrated includes a clamp that can be tightened to bear against the inner wall defining the slot 29 in the rail 28a, 28b, and can be loosened to allow fore and aft adjustment. The bracket 36 enables the adjustable cross bar 34 to resist removal from the slot 29 in response to transverse forces. The rails 28a, 28b, the rear transverse end bar 30, and the adjustable cross bar 34 share a common plane.

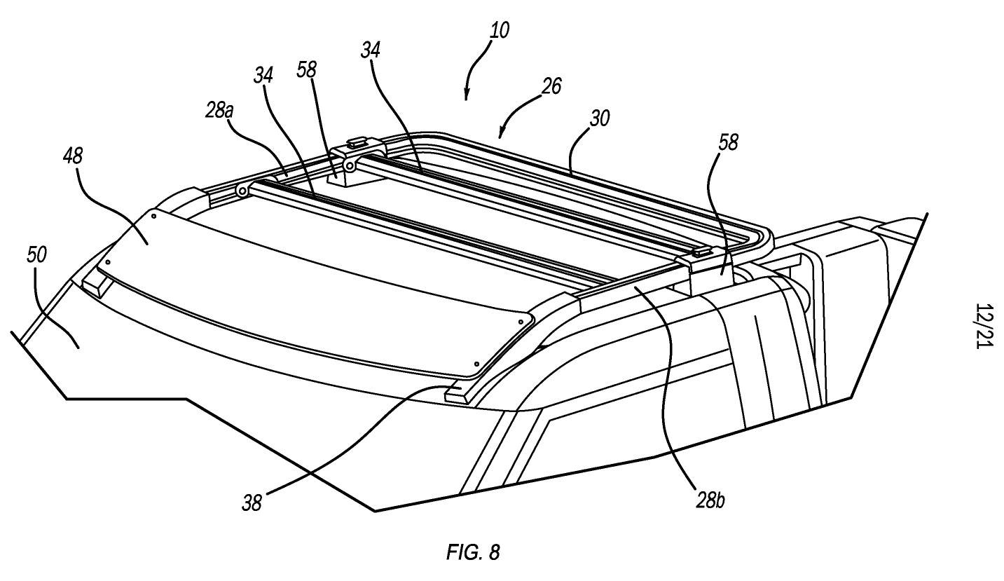

Two end caps 38 are shown in FIGS. 2A, 3A, 3B and 9, and the end caps 38 are employed to cover at least the forward end of each of the rails 28a, 28b. The end caps 38 are fastened to the vehicle roof via fastener 42 . The end cap 38 optionally has a cover 43 to cover the fastener 42 when viewed from above. Each end cap 38 includes a forward portion 40 that slopes downward. The forward portion 40 has an outer surface 66 that is below the planar roof toward the wind screen 50 of the vehicle. Depicted also are optional through holes 47, which may permit access to attachment hardware and/or to a front spoiler or wing 48 so that there is little or no gap between the front spoiler or wing 48 and the forward end of the roof (FIGS. 8, 9,) .The end cap 38 may include a rearward portion 44 that enables its associated rail to be elevated and spaced apart from an exterior surface of the vehicle. The rearward portion 44 has an upper portion 68 and a lower portion 70 that engage with each of the rails 28a, 28b to maintain the rails elevated and spaced apart from the roof of the vehicle. Here it is seen that the forward portion 40 has a forward contoured edge region 46a and the rearward portion 44 has a rearward contoured edge region 46b. Shown here, the radius of curvature of edge regions 46a and 46b differ in a manner to enable the elevation and spacing from the roof. The end caps 38 adjoin a top of the front wind screen 50 within a distance of less than 1 centimeter.

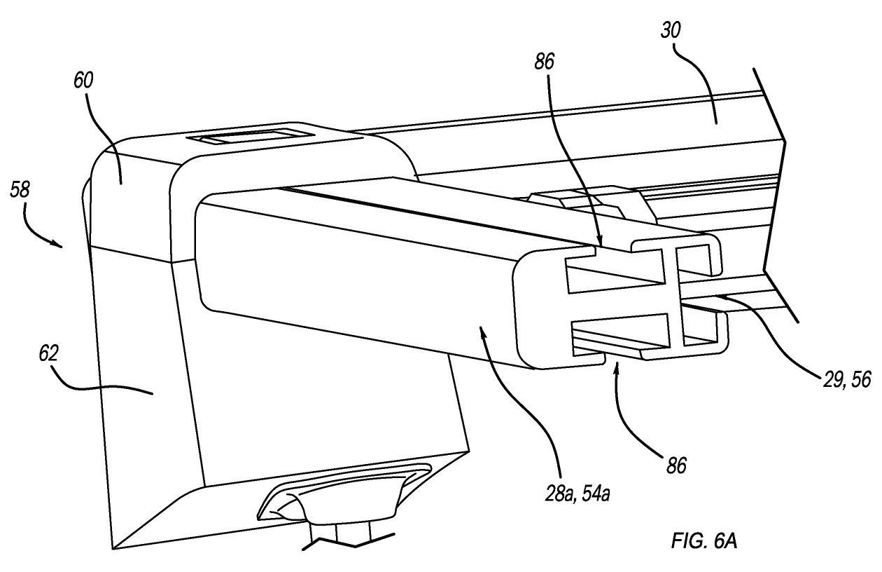

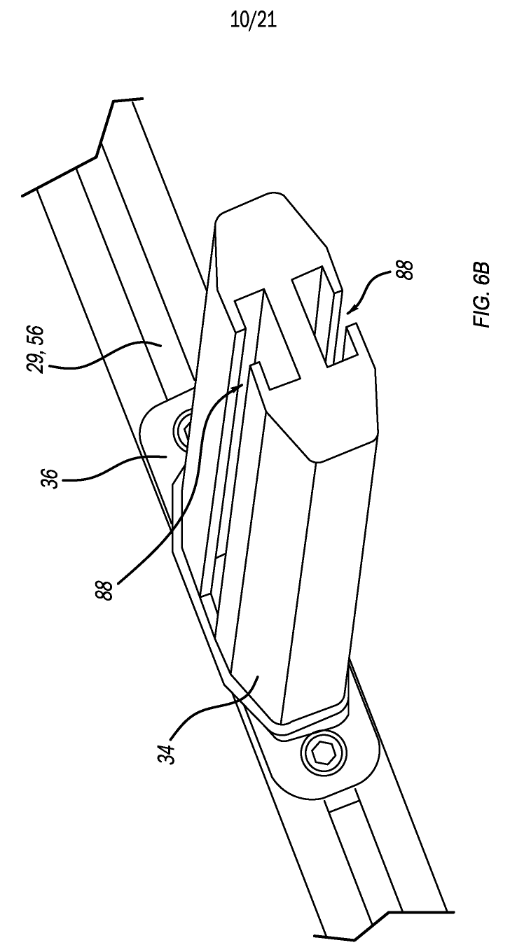

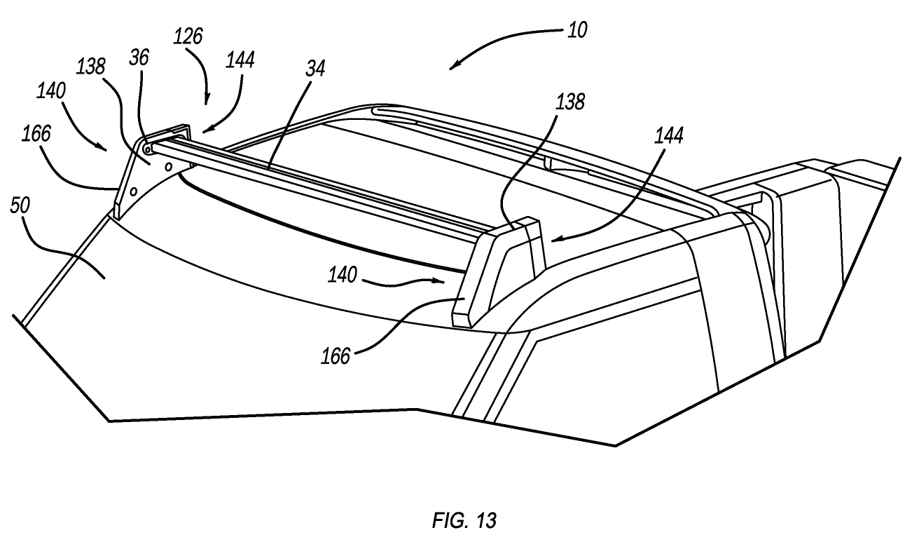

Turning to FIG. 13, there is depicted the truck configuration 10 having a third article carrier system 126. Two end caps 138 are shown in FIG. 13. The end caps 138 are fastened to the vehicle roof and/or vehicle frame via at least one fastener. Each end cap 138 has a forward portion 140 that slopes downward. The forward portion 140 has an outer surface 166 that is below the planar roof toward the wind screen 50 of the vehicle. The end cap 138 may include a rearward portion 144 that has an end cap slot (not shown) that receives an adjustable cross bar 34 and/or bracket 36 (FIG. 6B). The bracket 36 provides a mechanism to permit a mechanical locking attachment to the end cap slot. As possible with other mechanical locking attachments herein, the bracket 36 illustrated includes a clamp that can be tightened to bear against the inner wall defining the end cap slot, and can be loosened to allow fore and aft adjustment. The bracket 36 enables the adjustable cross bar 34 to resist removal from the end cap slot in response to transverse forces. The end caps 138 adjoin a top of the front wind screen 50 within a distance of less than 1 centimeter.

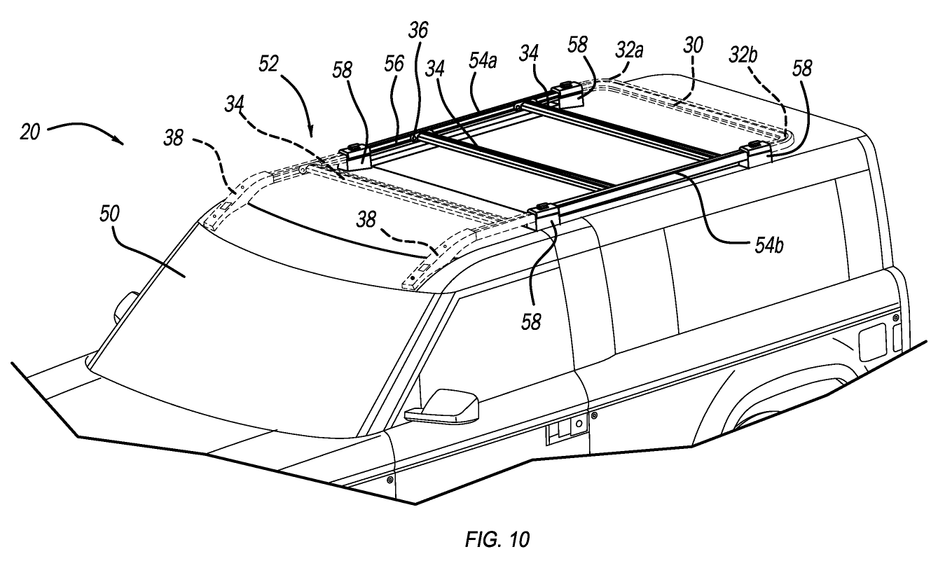

Turning to FIGS. 2B and 10, there is depicted the SUV configuration 20 having second article carrier system 52. The second article carrier system 52 includes a pair of roof slots (e.g., a left roof slot 23a and a right roof slot 23b (FIG. 1B)). The second article carrier system 52 includes a second pair of longitudinally aligned spaced apart rails (e.g., a second left rail 54a and a second right rail 54b) each having a second length, longer than the first length, each having a longitudinally extending slot 56 that includes a slot opening along the longitudinal direction that faces toward the longitudinal axis (e.g., central longitudinal axis) of the vehicle, and being mounted on the vehicle roof.

The second article carrier system 52 includes a rear transverse end bar 30. Such rear transverse end bar 30 may have a first end corner region 32a on its left side (e.g., left corner region 32a) and a second end corner region 32b on its right side (e.g., right corner region 32b). The rear transverse end bar 30 is connected at the left corner region 32a to the second left rail 54a. The rear transverse end bar 30 is connected at the right corner region 32b to the second right rail 54b.

The rear transverse end bar 30 is elevated and spaced apart from a roof surface of the vehicle. Four stanchions 58 are located on the roof of the vehicle Two of the stanchions 58 connect to the left corner region 32a and the right corner region 32b, respectively, of the rear transverse end bar 30 to maintain the elevation and spacing. These two stanchions 58 have a lower portion that is secured to the vehicle roof and an upper portion that receives the rear transverse end bar 30. The upper portions of these two stanchions 58 also receive rails 54a and 54b respectively. The other two stanchions 58 located on a more forward portion of the roof have a lower portion that is secured to the vehicle roof and an upper portion that receives rails 54a and 54b respectively.

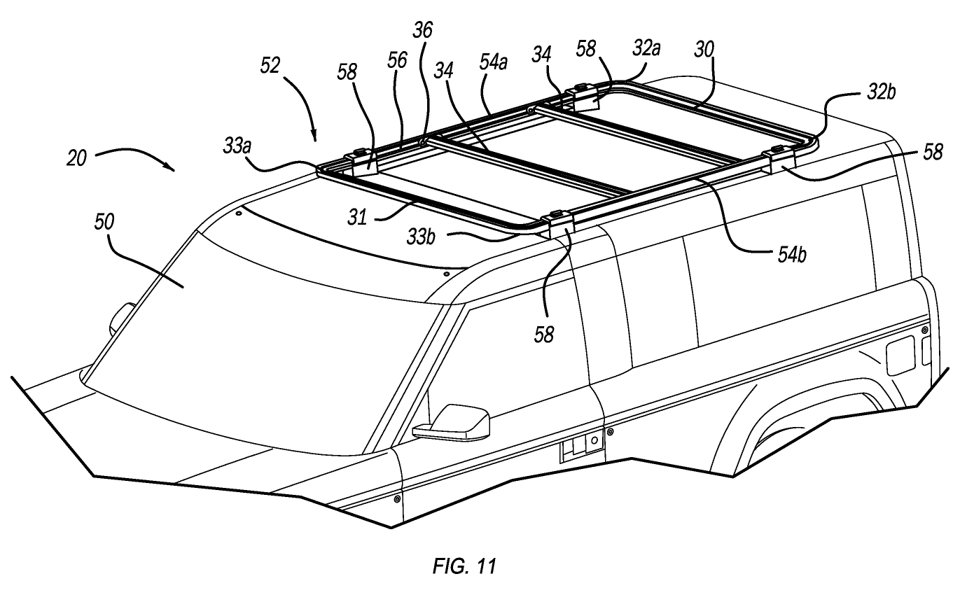

The second article carrier system 52 includes adjustable cross bars 34 (FIG. 10 shows three adjustable cross bars 34 and FIG. 11 shows two adjustable cross bars 34), each located forward of the transverse end bar 30 and each being longitudinally adjustable between at least two positions. The adjustable cross bars 34 may be securable to the rails 54a, 54b and configured for longitudinal adjustment between at least two positions via the slot 56. By way of example, the adjustable cross bars 34 may have an associated structure, such as an end bracket 36 (FIG. 6B), that provides a mechanism to permit a mechanical locking attachment to the rails 54a, 54b. As possible with other mechanical locking attachments herein, the bracket 36 illustrated includes a clamp that can be tightened to bear against the inner wall defining the slot 56 in the rail 54a, 54b, and can be loosened to allow fore and aft adjustment. The bracket 36 enables each of the adjustable cross bars 34 to resist removal from the slot 56 in response to transverse forces. The rails 54a, 54b, the rear transverse end bar 30, and the adjustable cross bars 34 share a common plane.

Two end caps 38 are shown in FIGS. 2B, 3B, and 10, and the end caps 38 are employed to cover at least the forward end of each of the rails 54a, 54b. The end caps 38 are fastened to the vehicle roof via fastener 42 . The fastener 42 optionally has a cover 43 (FIG. 3A). Each end cap 38 includes a forward portion 40 that slopes downward. The forward portion 40 has an outer surface 66 that is below the planar roof toward the wind screen 50 of the vehicle. Depicted also are optional through holes 47, which may permit access to attachment hardware and/or to a front spoiler or wing 48 so that there is little to no gap between the front spoiler or wing 48 and the forward end of the roof (FIG. 10). The end cap 38 may include a rearward portion 44 that enables its associated rail to be elevated and spaced apart from an exterior surface of the vehicle. The rearward portion 44 has an upper portion 68 and a lower portion 70 that engage with each of the rails 54a, 54b to maintain the rails elevated and spaced apparat from the roof of the vehicle. Here it is seen that the forward portion 40 has a forward contoured edge region 46a and the rearward portion 44 has a rearward contoured edge region 46b. Shown here, the radius of curvature of edge regions 46a and 46b differ in a manner to enable the elevation and spacing from the roof. The end caps 38 adjoin a top of the front wind screen 50 within a distance of less than 1 centimeter.

FIG. 11 shows a forward transverse end bar 31 instead of end caps 38. The forward transverse end bar 31 resembles and employs geometry like that of the rear transverse end bar 30. The forward transverse end bar 31 has arcuate corner geometry at each a first end corner region (e.g., left corner region 33a) and a second end corner region (e.g., right corner region 33b) for defining a bow structure. The forward transverse end bar 31 is elevated and spaced apart from a roof surface of the vehicle. The forward transverse end bar 31 is connected at the left corner region 33a to the second left rail 54a. The forward transverse end bar 31 is connected at the right corner region 33b to the second right rail 54b. The connections of the left corner region 33a and the right corner region 33b are located at the forward end of each respective rail 54a and 54b. Preferably, the two stanchions 58 located on a more forward portion of the roof have a lower portion that is secured to the vehicle roof and/or vehicle frame and an upper portion that receives rails 54a and 54b respectively and the left corner region 33a and the right corner region 33b respectively. The rails 54a, 54b, the rear transverse end bar 30, the adjustable cross bars 34, and the forward transverse end bar 31 share a common plane.

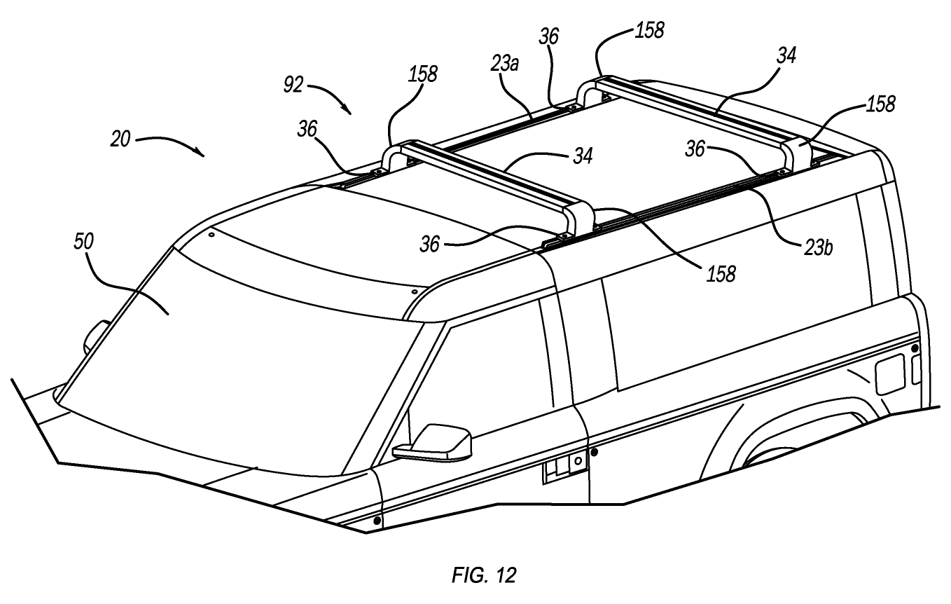

Turning to FIG. 12, there is depicted the SUV configuration 20 having a fourth article carrier system 92. The fourth article carrier system 92 includes a pair of roof slots (e.g., a left roof slot 23a and a right roof slot 23b). Four stanchions 158 are located on the roof of the vehicle connected to the roof slots 23a, 23b. Two of the stanchions 158 connect to the left roof slot 23a where one is located on a more forward portion of the roof, and two of the stanchions 158 connect to the right roof slot 23b where one is located on a more forward portion of the roof. The stanchions 158 each have a lower portion that is secured to the vehicle roof via the roof slots 23a, 23b. The stanchions 158 are each longitudinally adjustable between at least two positions via the roof slots 23a, 23b. The stanchions 158 each have an associated structure, an end bracket 36 (FIG. 6B), that provides a mechanism to permit a mechanical locking attachment to the roof slots 23a, 23b. The bracket 36 illustrated includes a clamp that can be tightened to bear against the inner wall defining the roof slot 23a, 23b, and can be loosened to allow fore and aft adjustment. The bracket 36 enables each of the stanchions 158 to resist removal from the roof slots 23a, 23b in response to transverse forces. The stanchions 158 each have an upper portion positioned at an angle of substantially 90 degrees relative to the lower portion, where the upper portion receives an adjustable cross bar 34.

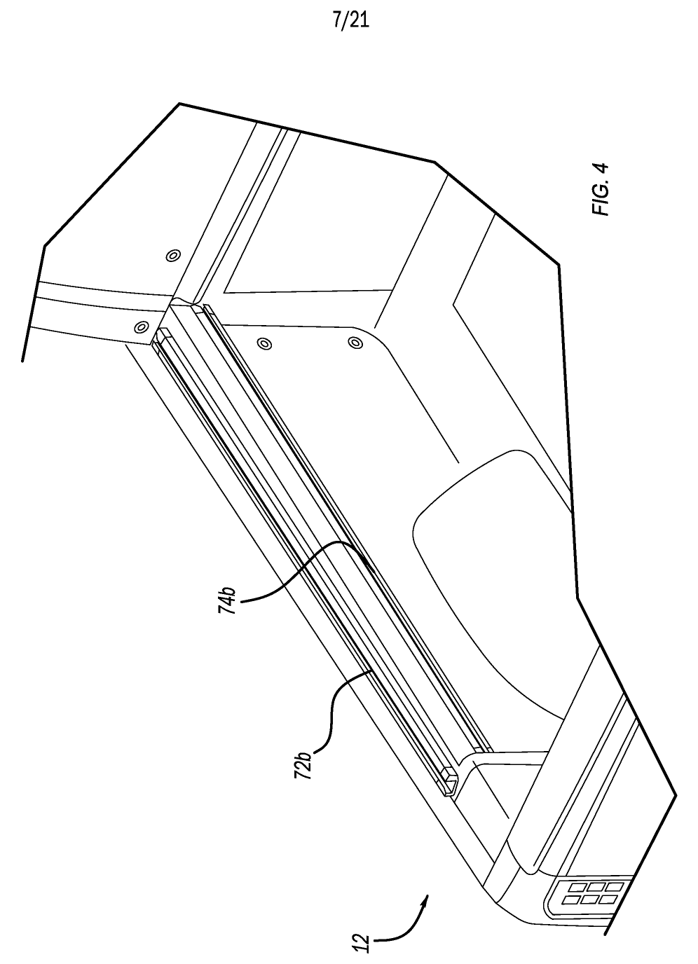

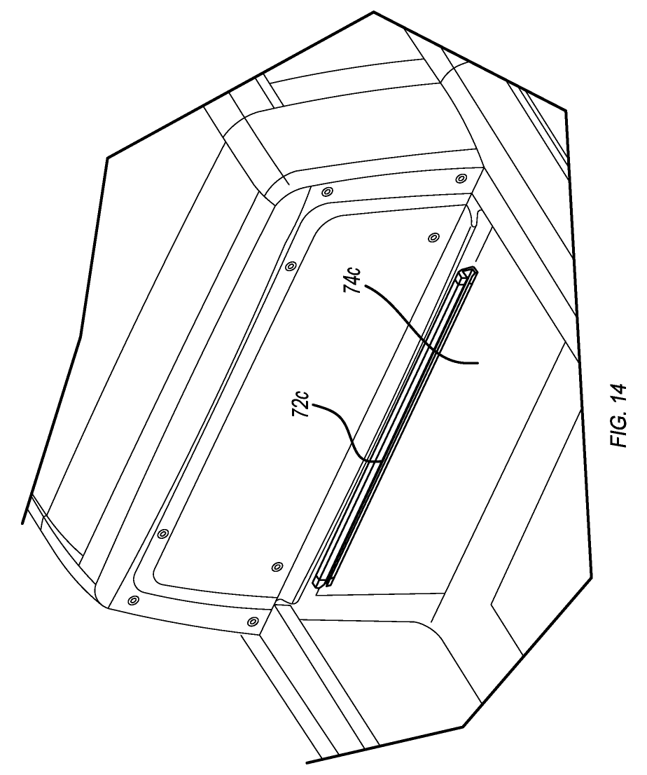

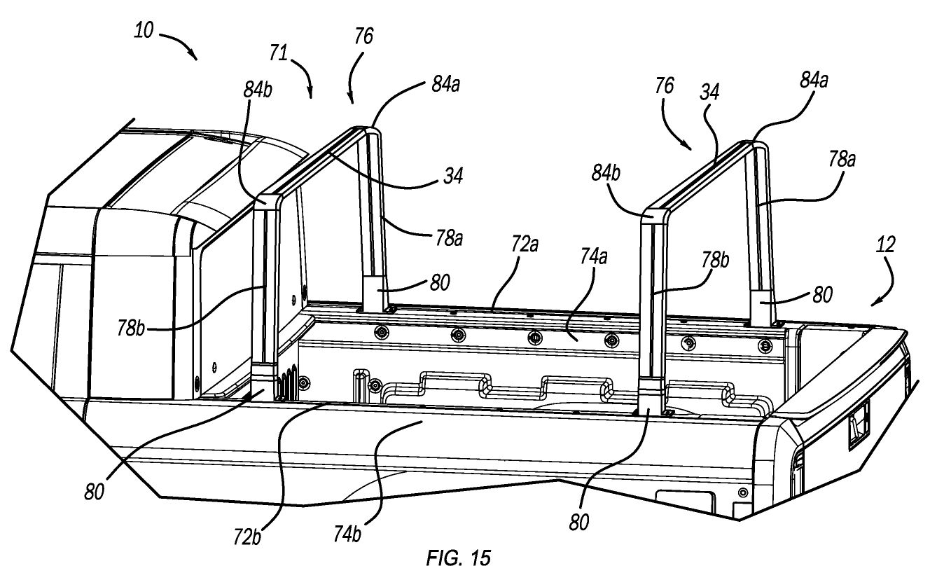

Turning to FIGS. 4, 5, 14, 15, 16 and 17, there is depicted a rack assembly 71 that supports articles overhead of a truck bed 12 when the vehicle is in a pickup truck configuration 10. The rack assembly 71 includes a pair of longitudinally aligned slotted bed rails (e.g., a left bed rail 72a and a right bed rail 72b) for attachment to an upper portion of a bed wall (e.g., an upper portion of the left bed wall 74a and an upper portion of the right bed wall 74b) of a vehicle when in the pickup truck configuration 10. The rack assembly 71 optionally includes a slotted bed rail (e.g., a center bed rail 72c) for attachment to an upper portion of a bed wall (e.g., an upper portion of the center bed wall 74c).

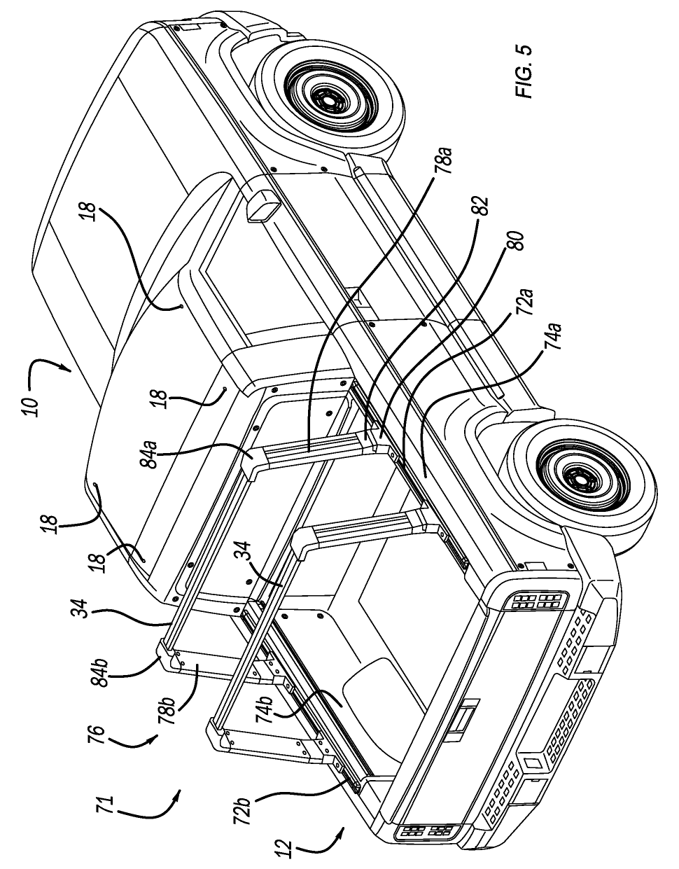

As seen in FIGS. 5, 15, and 16, the rack assembly 71 includes two upright assemblies 76 secured to the slotted bed rails 72a, 72b. The upright assembly 76 includes a left upright arm 78a attached to the left slotted bed rail 72a via a bracket 80 and optionally a connection piece 82 (FIG. 5), and a right upright arm 78b attached to the right slotted bed rail 72b via bracket 80 and optionally a connection piece 82 (FIG. 5). The left upright arm 78a and the right upright arm 78b are joined together by an adjustable cross bar 34 via a left corner bracket 84a and a right corner bracket 84b. The upright assembly 76 is longitudinally adjustable and securable between at least two different longitudinal positions via bracket 80.

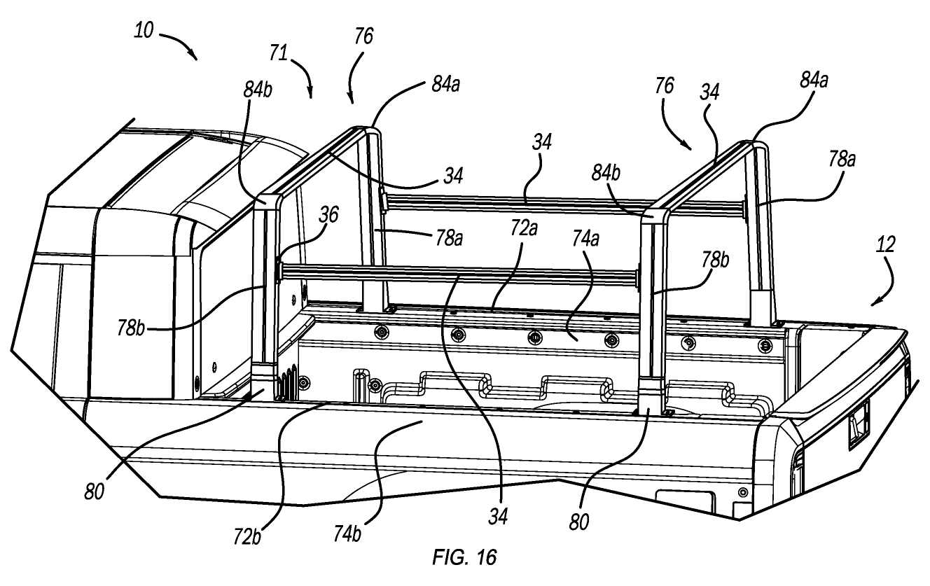

FIG. 16 shows a pair of longitudinally extending adjustable cross bars 34 that join together the two upright assemblies 76. Each longitudinally extending adjustable cross bar 34 is connected to the left upright arms 78a and the right upright arms 78b, respectively, via an upright arm slot (e.g., T-shaped slot on each of the left upright arms and the right upright arms) and/or a bracket 36 (FIG. 6B). The bracket 36 provides a mechanism to permit a mechanical locking attachment to the upright arm slot. As possible with other mechanical locking attachments herein, the bracket 36 illustrated includes a clamp that can be tightened to bear against the inner wall defining the upper arm slot, and can be loosened to allow vertical adjustment. The bracket 36 enables each of the adjustable cross bars 34 to resist removal from the upper arm slot in response to transverse forces.

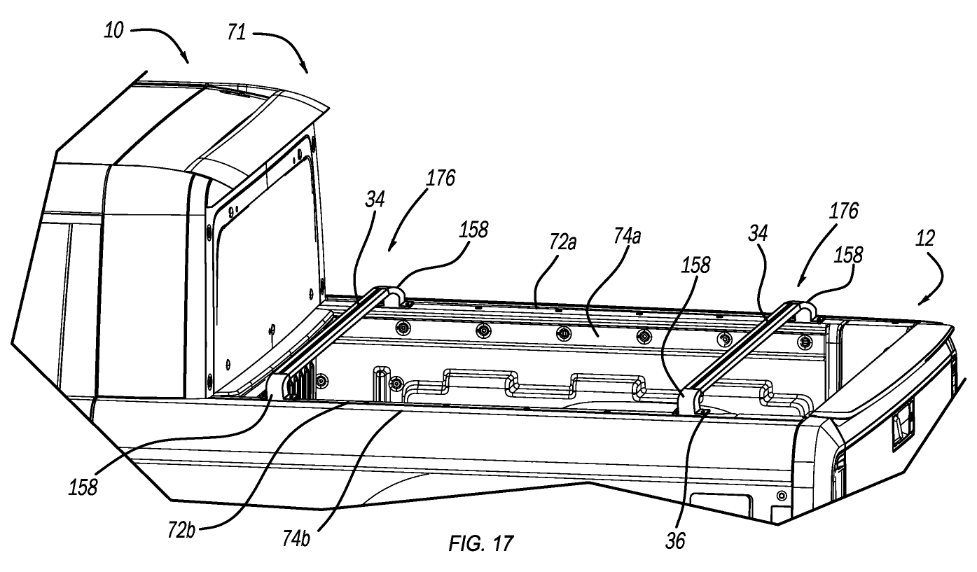

FIG. 17 shows the rack assembly 71 which includes two upright assemblies 176 secured to the slotted bed rails 72a, 72b. The upright assembly 176 includes two stanchions 158 each having a lower portion that is connected to the slotted bed rails 72a, 72b. The stanchions 158 are each longitudinally adjustable between at least two positions via the slotted bed rails 72a, 72b. The stanchions 158 may each have an associated structure, such as an end bracket 36 (FIG. 6B), that provides a mechanism to permit a mechanical locking attachment to the slotted bed rails 72a, 72b. As possible with other mechanical locking attachments herein, the bracket 36 illustrated includes a clamp that can be tightened to bear against the inner wall defining the slotted bed rails 72a, 72b, and can be loosened to allow fore and aft adjustment. The bracket 36 enables each of the stanchions 158 to resist removal from the slotted bed rails 72a, 72b in response to transverse forces. The stanchions 158 each have an upper portion positioned at an angle of substantially 90 degrees relative to the lower portion, where the upper portion receives an adjustable cross bar 34.

Turning to FIG. 6A, there is depicted a left rail 28a, 54a which has a profile geometry that provides a track on three portions of the profile. Specifically, the profile geometry defines three T-shaped slot profiles. One of the T-shaped slot profiles is slot 29, 56. Slots 23a and 23b have similar T-shaped slot profiles as slot 29, 56. The other two T-shaped slot profiles 86 are located on the top and bottom of the left rail 28a, 54a. The right rail 28b, 54b has a similar profile geometry.

Turning to FIG. 6B, there is depicted an adjustable cross bar 34 which has a profile geometry that provides a track on two portions of the profile. Specifically, the profile geometry defines two T-shaped slot profiles 88 located on the top and bottom of the adjustable cross bar 34.

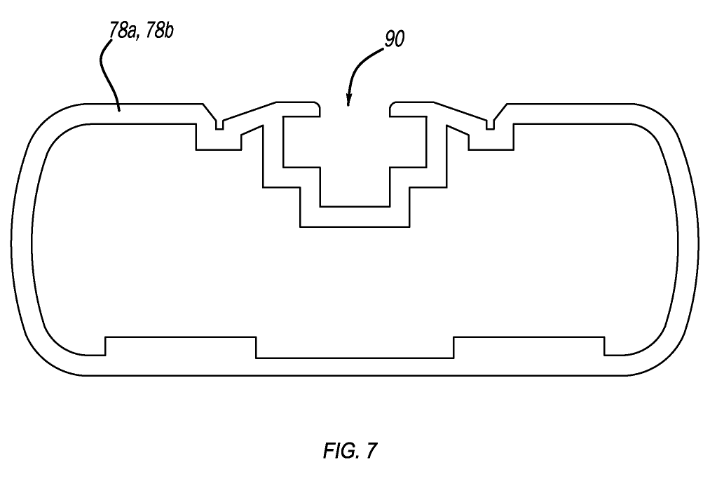

Turning to FIG. 7, there is depicted a profile geometry of the left upright arm 78a and the right upright arm 78b defining a T-shaped slot profile 90. The T-shaped slot profile 90 may be able to receive a component and/or a rubber seal. Although not shown, more than one T-shaped slot profiles 90 may define the profile geometry of the left upright arm 78a and the right upright arm 78b (e.g., there may be a T-shaped slot profile 90 on all four sides).

Turning to FIG. 8, there is depicted the vehicle in the truck configuration 10 with the article carrier system 26 in which there are two adjustable cross bars 34. Also, the endcaps 38 are connected to a front spoiler or wing 48 so that there is little or no gap between the front spoiler or wing 48 and the forward end of the roof. The stanchions 58 form a c-shape and receive the rails 28a, 28b and/or the rear transverse end bar 30. The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

What is claimed is:

1. A transformable article carrier system for an automotive vehicle having a vehicle frame, the automotive vehicle being reversibly configurable between a pickup truck configuration and a sport utility vehicle configuration, the transformable article carrier system being capable of being reversibly modified among a first state for use on the vehicle when it is in the pickup truck configuration and a second state for use on the vehicle when it is in the sport utility vehicle configuration, comprising:
a) a first pair of longitudinally aligned spaced apart rails being a first left rail and a first right rail, each having a first length and being configured for attachment to a roof of the vehicle on either side of a central longitudinal axis of the vehicle, each rail having a forward end and a rearward end;
b) a rear transverse end bar having a first end corner region being a left end region and a second end corner region being a right end region, and being connected at the first end corner region to the first left rail and being connected at the second end corner region to the first right rail, the connections of the first end corner region and a second end corner region being located at the rearward end of each respective rail; and
c) an adjustable cross bar located forward of the rear transverse end bar and being longitudinally adjustable between at least two positions, and being mechanically securable via a friction fit, an interlock, a cam lock, a locking pin through an opposing aperture, or a clamp to the rails, between at least two positions; and
d) an end cap that covers the forward end of each of the rails.

2. The transformable article carrier system of claim 1, wherein the transformable article carrier is reversibly transformable from a first state in which the transformable article carrier is attached to the roof of a vehicle configured as a pickup truck having no rear seat and no cargo area enclosure to a second state when the transformable article carrier is attached to the roof of a vehicle configured as a sport utility vehicle having a rear seat and/or a cargo area enclosure.

3. The transformable article carrier system of claim 1, wherein the transformable article carrier system includes at least one second pair of longitudinally aligned spaced apart rails being a second left rail and a second right rail, each having a second length and being configured for attachment using original equipment hardware provided on the vehicle frame including frame fastening devices, accessory fastening devices, weld nuts, a threaded opening, and/or a threaded fastener that is exposed and visible to an observer located outside of the vehicle and within 3 meters of the hardware to the roof of a vehicle on a respective side of a central longitudinal axis of the vehicle, each rail of the second pair of longitudinally aligned spaced apart rails having a forward end and a rearward end, and the second length is longer than the first length by at least 120% and/or the second length is longer than the first length by less than 400%.

4. The transformable article carrier system of claim 3, wherein any or all of the rails of the first or second pairs of longitudinally aligned spaced apart rails have a constant profile over at least 50% of its respective first or second length.

5. The transformable article carrier system of claim 1, wherein each of the longitudinally aligned spaced apart rails are an extrusion that defines a longitudinally extending slot, and/or each of the longitudinally aligned spaced apart rails is configured to include a longitudinally extending slot that includes a slot opening along the longitudinal direction that faces toward the central longitudinal axis of the vehicle and/or each of the longitudinally aligned spaced apart rails are configured to be interchangeably used on either side of the vehicle, and further wherein any longitudinally extending slot is configured for providing a T-profiled track along which an adjustable cross bar can slide.

6. The transformable article carrier system of claim 1, wherein the rear transverse end bar has an arcuate corner geometry at each of the first end corner region and the second end corner region for defining a bow structure, and/or wherein the rear transverse end bar is elevated and spaced apart from a roof surface of the vehicle.

7. The transformable article carrier system of claim 1, wherein the transformable article carrier system includes a stanchion for supporting either or both of the rear transverse end bar and one of the rails, and wherein the stanchion is configured with a lower portion that secures to the roof of the vehicle using original equipment hardware provided on the vehicle frame and/or the roof of the vehicle, including frame fastening devices, accessory fastening devices, weld nuts, a threaded opening and/or a threaded fastener that is exposed and visible to an observer located outside of the vehicle and within 3 meters of the hardware, and an upper portion that wraps partially or entirely around an outer end bar and/or outer rail surface and exhibiting a c-shape.

8. The transformable article carrier system of claim 1, wherein the rear transverse end bar abuttingly and/or matingly and/or removably engages with each of the longitudinally aligned spaced apart rails, the first end corner region of the rear transverse end bar engaging the rearward end of one of the rails, and the second end corner region engaging the rearward end of the other rail.

9. The transformable article carrier system of claim 3, wherein the transformable article carrier system also includes a forward transverse end bar, and the forward transverse end bar has a first end corner region and a second end corner region, and being connected at its first end corner region to one of the longitudinally aligned spaced apart rails of the second pair and being connected at its second end corner region to the other one of the longitudinally aligned spaced apart rails of the second pair, the connections of the first end corner region and the second end corner region being located at the forward end of each respective rail.

10. The transformable article carrier system of claim 9, wherein the forward transverse end bar has an arcuate corner geometry at each of the first end corner region and the second end corner region for defining a bow structure, and exhibiting a mirror symmetry with the rear transverse end bar; and/or wherein the forward transverse end bar is elevated and spaced apart from a roof surface of the vehicle; and/or wherein the forward transverse end bar matingly and/or abuttingly and/or removably engages with each rail of the second pair of the longitudinally aligned spaced apart rails, the first end corner region of the forward transverse end bar engaging the forward end of one of the rails, and the second end corner region of the forward transverse end bar engaging the forward end of the other rail.

11. The transformable article carrier system of claim 1, wherein the end cap that covers the forward end of each of the rails, fastens to the roof of the vehicle and/or the vehicle frame, and includes one or any combination of (i) a contoured forward portion that has an outer surface that extends slopingly beyond and beneath a planar roof portion toward a windscreen of the vehicle; (ii) a rearward portion that has an upper portion and a lower portion configured to matingly and/or abuttingly and/or removably engage with the forward end of each of the rails to maintain the rails elevated and spaced apart from a roof surface of the vehicle.

12. The transformable article carrier system of claim 7, wherein the rails and the rear transverse end bar and the adjustable cross bar share a common plane over most of its overall length, and the end caps have a forward most end that is located below the common plane, and/or located below the bottom of any stanchion after vehicle installation, and/or adjoins a top of the front wind screen within a distance of less than 5 cm.

13. The transformable article carrier system of claim 1, wherein the adjustable cross bar is configured to slide fore and aft along the respective longitudinally aligned spaced apart rails, and to be secured in place upon reaching a desired position by a mechanical attachment including an interference fit including a friction fit, an interlock, a cam lock, a locking pin through an opposing aperture, or a clamp.

14. The transformable article carrier system of claim 1, wherein the adjustable cross bar is configured at its ends to include a projection that is insertable to define an interference fit within a complementary opening in the longitudinally aligned spaced apart rails to resist removal in response to transverse forces.

15. The transformable article carrier system of claim 1, wherein the transformable article carrier system also includes a pair of longitudinally aligned slotted bed rails for attachment to an upper portion of a bed wall of a vehicle in the pickup truck configuration, and at least one upright assembly that secures to the slotted bed rails and includes one first upright arm being attachable to a respective slotted bed rail, and another second upright arm being attachable to the other respective slotted bed rail, the first and the second upright arms being joined together, by an adjustable cross bar, and/or the at least one upright assembly being longitudinally adjustable and securable between different longitudinal positions.

16. The transformable article carrier system of claim 1, wherein any adjustable cross bar, any end bar, and/or any rail includes a profile geometry that provides a track on at least two portions of the profile, and/or the profile geometry defines a T-shaped slot profile along at least 50% of its length, and the profile geometry defines at least two T-shaped slot profiles located at an angle relative to each other, vertically aligned with each other, or juxtaposed with each other.

17. A vehicle including the transformable article carrier system of claim 1, wherein the vehicle has a vehicle frame that, in its original equipment condition includes a roof panel support structure, the roof panel support structure including four fastening sites defined therein in the form of frame fastening devices, accessory fastening devices, weld nuts, a threaded stud, or a threaded opening, and located respectively at corner regions of the roof of the vehicle, within 20 centimeters of an upper end of each of a left vehicle A-pillar, a right vehicle A-pillar, a left vehicle B-pillar and a right vehicle B-pillar of the vehicle.

18. The vehicle of claim 17, wherein the vehicle is reversibly configurable between a pickup truck and a sport utility vehicle, without destruction of vehicle components, and wherein the vehicle includes a propulsion system that is electric and is free of an internal combustion engine.

19. A method of using the transformable article carrier system of claim 3, comprising the steps of installing the transformable article carrier system on the reversibly configurable vehicle when the vehicle is in a pickup truck configuration using the first pair of longitudinally aligned spaced apart rails; and replacing the first pair of longitudinally aligned spaced apart rails with the second pair of longitudinally aligned spaced apart rails that are longer than the first pair, when the vehicle is in the sport utility vehicle configuration.

20. The method of claim 19, wherein the method includes removing any end caps and/or attaching a forward transverse end bar.
